(19) United States
(12) Patent Application Publication
(10) Pub. No.: US 2024/0284377 A1
(43) Pub. Date: Aug. 22, 2024

(54) METHOD OF USER EQUIPMENT (UE), USER EQUIPMENT (UE), METHOD OF COMMUNICATION APPARATUS AND COMMUNICATION APPARATUS

(71) Applicant: NEC Corporation, Minato-ku, Tokyo (JP)

(72) Inventors: Kundan TIWARI, Tokyo (JP); Toshiyuki TAMURA, Tokyo (JP); Iskren IANEV, Tokyo (JP)

(73) Assignee: NEC Corporation, Minato-ku, Tokyo (JP)

(21) Appl. No.: 18/568,397

(22) PCT Filed: May 18, 2022
(86) PCT No.: PCT/JP2022/020687

§ 371 Date: Dec. 8, 2023

(30) Foreign Application Priority Data
Jun. 10, 2021 (IN) 202111025931

(51) Int. Cl. H04W 60/04; H04W 48/18; H04W 84/04

(52) U.S. Cl. CPC H04W 60/04; H04W 48/18; H04W 84/042

(57) ABSTRACT

[Problem]

This disclosure defines a procedure to solve problem how the NSSRG needs to be handled in some situations

[Solution]

A method of a User Equipment (UE) includes performing communication with a network apparatus and including first Single Network Slice Selection Assistance Information (S-NSSAI) to Requested Network Slice Selection Assistance Information (NSSAI) for a first access. The first S-NSSAI shares Network Slice Simultaneous Registration Group (NSSRG) common to second S-NSSAI of Allowed NSSAI for a second access.

### TECHNICAL FIELD

The present disclosure related to a method of a User Equipment (UE) and a User Equipment (UE).

### BACKGROUND ART

The Network Slice Simultaneous Registration Group (NSSRG) concept is introduced by NPL 5 during the 3GPP SA Working Group 145E meeting. The NSSRG concept is introduced to the 5GS based on the service requirement form the GSMA as described in NPL 2.

According to NPL 5, the subscription information for a UE may include for each S-NSSAI a NSSRG information constraining which S-NSSAIs can be simultaneously provided to the UE in the Allowed NSSAI.

If the UE has received NSSRG information together with the Configured NSSAI, the UE only includes in the Requested NSSAI S-NSSAIs that all share a common NSSRG, for example, when the UE sends a Registration request message to an AMF.

Two S-NSSAIs sharing at least one NSSRG can be simultaneously included in the Allowed NSSAI. Otherwise, these S-NSSAIs cannot be included simultaneously in the Allowed NSSAI. For example, in a case where a first NSSRG only includes first S-NSSAI and a second NSSRG only includes second S-NSSAI, these S-NSSAIs cannot be included simultaneously in the Allowed NSSAI.

The NSSRG information, defining the association of S-NSSAIs to NSSRG, is provided as an additional and separate information. A supporting AMF/NSSF, when it receives a Requested NSSAI, evaluates the S-NSSAIs of the HPLMN (in the mapping information of the Requested NSSAI in the registration request message, when a mapping information is applicable) based on any received NSSRG information for these S-NSSAIs, to determine whether they can be provided together in the Allowed NSSAI.

### CITATION LIST

### Non Patent Literature

[NPL 1] 3GPP TR 21.905: “Vocabulary for 3GPP Specifications”. V16.0.0 (2019-06)
[NPL 2] GSM Association Official Document NG.116: “Generic Network Slice Template” V2.0 (2019-10) -https://www.gsma.com/newsroom/wp-content/uploads/NG.116-v2.0.pdf
[NPL 3] 3GPP TS 23.501: “System architecture for the 5G System (5GS)”. V17.0.0 (2021-03)
[NPL 4] 3GPP TS 23.502: “Procedures for the 5G System (5GS)”. V17.0.0 (2021-03)
[NPL 5] S2-2104913: “Introduction of support of NG. 116 attribute ‘Simultaneous Use of a Network Slice’”-https://www.3gpp.org/ftp/tsg_sa/WG2_Arch/TSGS2_145E_Electronic_2021-05/Docs/S2-2104913.zip

### SUMMARY OF INVENTION

### Technical Problem

According to NPL 5, the NSSRG is configured for the UE in a HPLMN as the subscription information. Inventors of this disclosure identify problem how the NSSRG needs to be handled in some situations.

### Solution to Problem

In an aspect of the present disclosure, a method of a User Equipment (UE) includes performing communication with a network apparatus and including first Single Network Slice Selection Assistance Information (S-NSSAI) to Requested Network Slice Selection Assistance Information (NSSAI) for a first access. The first S-NSSAI shares Network Slice Simultaneous Registration Group (NSSRG) common to second S-NSSAI of Allowed NSSAI for a second access.

In an aspect of the present disclosure, a User Equipment (UE) includes means for performing communication with a network apparatus and means for including first Single Network Slice Selection Assistance Information (S-NSSAI) to Requested Network Slice Selection Assistance Information (NSSAI) for a first access. The first S-NSSAI shares Network Slice Simultaneous Registration Group (NSSRG) common to second S-NSSAI of Allowed NSSAI for a second access.

### BRIEF DESCRIPTION OF DRAWINGS

FIG. 1 illustrates Registration procedure based on Network Slice Simultaneous Registration Group Policy.

FIG. 2 illustrates Registration procedure to different PLMNs via 3GPP access and non-3GPP access.

FIG. 3 illustrates Registration procedure to a PLMN via 3GPP access and non-3GPP access.

FIG. 4 illustrates NSSRG transfer between AMFs.

FIG. 5 illustrates NSSRG considerations in Handover.

FIG. 6 illustrates System overview.

FIG. 7 is a block diagram for a User equipment (UE).

FIG. 8 is a block diagram for a (R)AN node.

FIG. 9 illustrates System overview of (R)AN node based on O-RAN architecture.

FIG. 10 is a block diagram for a Radio Unit (RU).

FIG. 11 is a block diagram for a Distributed Unit (DU).

FIG. 12 is a block diagram for a Centralized Unit (CU).

FIG. 13 is a block diagram for an AMF.

FIG. 14 is a block diagram for a UDM.

### DESCRIPTION OF EMBODIMENTS

Each of aspects and elements included in the each aspects described below may be implemented independently or in combination with any other. These aspects include novel characteristics different from one another. Accordingly, these aspects contribute to achieving objects or solving problems different from one another and contribute to obtaining advantages different from one another. For example, Aspect 1 and Aspect 5 can be combined, Aspect 3 and Aspect 5 can be combined, Aspect 1 and Aspect 3 and Aspect 5 can be combined. For example, Aspect 1, Aspect 5 and at least one of variants of Aspect 3 can be combined. For example, Aspect 3, Aspect 5 and at least one of variants of Aspect 3 can be combined.

### <Abbreviations>

For the purposes of the present document, the abbreviations given in NPL 1 and the following apply. An abbreviation defined in the present document takes precedence over the definition of the same abbreviation, if any, in NPL 1.

| | |
|---|---|
| 4G-GUTI | 4G Globally Unique Temporary UE Identity |
| 5GC | 5G Core Network |
| 5GLAN | 5G Local Area Network |
| 5GS | 5G System |
| 5G-AN | 5G Access Network |
| 5G-AN PDB | 5G Access Network Packet Delay Budget |
| 5G-EIR | 5G-Equipment Identity Register |
| 5G-GUTI | 5G Globally Unique Temporary Identifier |
| 5G-BRG | 5G Broadband Residential Gateway |
| 5G-CRG | 5G Cable Residential Gateway |
| 5G GM | 5G Grand Master |
| 5G-RG | 5G Residential Gateway |
| 5G-S-TMSI | 5G S-Temporary Mobile Subscription Identifier |
| 5G VN | 5G Virtual Network |
| 5QI | 5G QoS Identifier |
| AF | Application Function |
| AMF | Access and Mobility Management Function |
| AS | Access Stratum |
| ATSSS | Access Traffic Steering, Switching, Splitting |
| ATSSS-LL | ATSSS Low-Layer |
| AUSF | Authentication Server Function |
| AUTN | Authentication token |
| BMCA | Best Master Clock Algorithm |
| BSF | Binding Support Function |
| CAG | Closed Access Group |
| CAPIF | Common API Framework for 3GPP northbound APIs |
| CHF | Charging Function |
| CN PDB | Core Network Packet Delay Budget |
| CP | Control Plane |
| DAPS | Dual Active Protocol Stacks |
| DL | Downlink |
| DN | Data Network |
| DNAI | DN Access Identifier |
| DNN | Data Network Name |
| DRX | Discontinuous Reception |
| DS-TT | Device-side TSN translator |
| ePDG | evolved Packet Data Gateway |
| EBI | EPS Bearer Identity |
| EPS | Evolved Packet System |
| EUI | Extended Unique Identifier |
| FAR | Forwarding Action Rule |
| FN-BRG | Fixed Network Broadband RG |
| FN-CRG | Fixed Network Cable RG |
| FN-RG | Fixed Network RG |
| FQDN | Fully Qualified Domain Name |
| GFBR | Guaranteed Flow Bit Rate |
| GMLC | Gateway Mobile Location Centre |
| GPSI | Generic Public Subscription Identifier |
| GUAMI | Globally Unique AMF Identifier |
| GUTI | Globally Unique Temporary UE Identity |
| HR | Home Routed (roaming) |
| IAB | Integrated access and backhaul |
| IMEI/TAC | IMEI Type Allocation Code |
| IPUPS | Inter PLMN UP Security |
| I-SMF | Intermediate SMF |
| I-UPF | Intermediate UPF |
| LADN | Local Area Data Network |
| LBO | Local Break Out (roaming) |
| LMF | Location Management Function |
| LoA | Level of Automation |
| LPP | LTE Positioning Protocol |
| LRF | Location Retrieval Function |
| MCC | Mobile country code |
| MCX | Mission Critical Service |
| MDBV | Maximum Data Burst Volume |
| MFBR | Maximum Flow Bit Rate |
| MICO | Mobile Initiated Connection Only |
| MITM | Man In the Middle |
| MNC | Mobile Network Code |
| MPS | Multimedia Priority Service |
| MPTCP | Multi-Path TCP Protocol |
| N3IWF | Non-3GPP InterWorking Function |
| N5CW | Non-5G-Capable over WLAN |
| NAI | Network Access Identifier |
| NEF | Network Exposure Function |
| NF | Network Function |
| NGAP | Next Generation Application Protocol |
| NID | Network identifier |
| NPN | Non-Public Network |
| NR | New Radio |
| NRF | Network Repository Function |
| NSI ID | Network Slice Instance Identifier |
| NSSAA | Network Slice-Specific Authentication |
| | and Authorization |
| NSSAAF | Network Slice-Specific Authentication and |
| | Authorization Function |
| NSSAI | Network Slice Selection Assistance Information |
| NSSF | Network Slice Selection Function |
| NSSP | Network Slice Selection Policy |
| NSSRG | Network Slice Simultaneous Registration Group |
| NW-TT | Network-side TSN translator |
| NWDAF | Network Data Analytics Function |
| PCF | Policy Control Function |
| PDB | Packet Delay Budget |
| PDR | Packet Detection Rule |
| PDU | Protocol Data Unit |
| PEI | Permanent Equipment Identifier |
| PER | Packet Error Rate |
| PFD | Packet Flow Description |
| PLMN | Public Land Mobile Network |
| PNI-NPN | Public Network Integrated Non-Public Network |
| PPD | Paging Policy Differentiation |
| PPF | Paging Proceed Flag |
| PPI | Paging Policy Indicator |
| PSA | PDU Session Anchor |
| PTP | Precision Time Protocol |
| QFI | QoS Flow Identifier |
| QoE | Quality of Experience |
| RACS | Radio Capabilities Signalling optimisation |
| (R)AN | (Radio) Access Network |
| RG | Residential Gateway |
| RIM | Remote Interference Management |
| RQA | Reflective QoS Attribute |
| RQI | Reflective QoS Indication |
| RSN | Redundancy Sequence Number |
| SA NR | Standalone New Radio |
| SBA | Service Based Architecture |
| SBI | Service Based Interface |
| SCP | Service Communication Proxy |
| SD | Slice Differentiator |
| SEAF | Security Anchor Functionality |
| SEPP | Security Edge Protection Proxy |
| SMF | Session Management Function |
| SMSF | Short Message Service Function |
| SN | Sequence Number |
| SN name | Serving Network Name. |
| SNPN | Stand-alone Non-Public Network |
| S-NSSAI | Single Network Slice Selection Assistance Information |
| SSC | Session and Service Continuity |
| SSCMSP | Session and Service Continuity Mode Selection Policy |
| SST | Slice/Service Type |
| SUCI | Subscription Concealed Identifier |
| SUPI | Subscription Permanent Identifier |
| SV | Software Version |
| TMSI | Temporary Mobile Subscriber Identity |
| TNAN | Trusted Non-3GPP Access Network |
| TNAP | Trusted Non-3GPP Access Point |
| TNGF | Trusted Non-3GPP Gateway Function |
| TNL | Transport Network Layer |
| TNLA | Transport Network Layer Association |
| TSC | Time Sensitive Communication |
| TSCAI | TSC Assistance Information |
| TSN | Time Sensitive Networking |
| TSN GM | TSN Grand Master |
| TSP | Traffic Steering Policy |
| TT | TSN Translator |
| TWIF | Trusted WLAN Interworking Function |
| UCMF | UE radio Capability Management Function |
| UDM | Unified Data Management |
| UDR | Unified Data Repository |
| UDSF | Unstructured Data Storage Function |
| UL | Uplink |
| UL CL | Uplink Classifier |
| UPF | User Plane Function |
| URLLC | Ultra Reliable Low Latency Communication |
| URRP-AMF | UE Reachability Request Parameter for AMF |
| URSP | UE Route Selection Policy |
| VID | VLAN Identifier |
| VLAN | Virtual Local Area Network |
| VPLMN | Visited PLMN |
| W-5GAN | Wireline 5G Access Network |
| W-5GBAN | Wireline BBF Access Network |
| W-5GCAN | Wireline 5G Cable Access Network |
| W-AGF | Wireline Access Gateway Function |

### Definitions

For the purposes of the present document, the terms and definitions given in NPL 1 and the following apply. A term defined in the present document takes precedence over the definition of the same term, if any, in NPL 1.

### <General>

Those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the Aspects of the present disclosure so as not to obscure the figures with details that will be readily apparent to those skilled in the art having the benefit of the description herein.

For the purpose of promoting an understanding of the principles of the disclosure, reference will now be made to the Aspect illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or entities or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an Aspect”, “in another Aspect” and similar language throughout this specification may, but not necessarily do, all refer to the same Aspect.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

As used herein, information is associated with data and knowledge, as data is meaningful information and represents the values attributed to parameters. Further knowledge signifies understanding of an abstract or concrete concept. Note that this example system is simplified to facilitate description of the disclosed subject matter and is not intended to limit the scope of this disclosure. Other devices, systems, and configurations may be used to implement the Aspects disclosed herein in addition to, or instead of, a system, and all such Aspects are contemplated as within the scope of the present disclosure.

The NSSRG policy includes information of the NSSRG. The NSSRG policy may be called as NSSRG slice selection policy, NSSRG information, NSSRG, information indicating NSSRG or information related to NSSRG. The NSSRG policy may include information indicating which S-NSSAI(s) in an Allowed NSSAI can be simultaneously provided to the UE. For example, the NSSRG policy includes information indicating that S-NSSAI 1 and S-NSSAI 2 can be simultaneously provided to the UE. In this case, the S-NSSAI 1 and the S-NSSAI 2 are included in the same NSSRG. The S-NSSAI 1 may be called as first S-NSSAI and the S-NSSAI 2 may be called as second S-NSSAI. Access type may be called as access. For example, 3GPP access type may be called as 3GPP access. For example, non-3GPP access type may be called as non-3GPP access.

In the following specifications, the allowed NSSAI can also be pending NSSAI. The registration request message can be for initial registration procedure, mobility registration procedure, periodic registration procedure or emergency registration procedure.

All the aspects also apply for the case when the UE is registered over an access type with an allowed NSSAI and an S-NSSAI in the requested NSSAI does not share a common NSSRG with the S-NSSAI(s) in the allowed NSSAI. All the aspects also apply for the case when the UE is registered over an access type with an allowed NSSAI and an S-NSSAI in the requested NSSAI of the same access type does not share a common NSSRG with the S-NSSAI(s) in the allowed NSSAI of the same access type.

### <First Aspect>

First Aspect can solve, for example, a problem statement 1 as shown below.

### <Problem Statement 1>

If the UE registers to a 5GS via both over 3GPP access and non-3GPP access, the UE maintains two independent Allowed NSSAIs, that is one for 3GPP access and another one for non-3GPP access.

It is not clear which S-NSSAI(s) can be set to the Requested NSSAI in the registration request message over an access type in a situation where the UE has been registered over another access type and has an Allowed NSSAI for another access type.

The first Aspect includes defining Network Slice Simultaneous Registration Group per access type (e.g. 3GPP access and non-3GPP access) for a PLMN and configuring this to the UE. The UE constitutes Requested NSSAI when registering to a PLMN via an access type as per the NSSRG of the access type. The network enforces the NSSRG policy to the UE as per the access type depending on which access type the UE is registering to the 5GS.

The detailed steps of the registration procedure using the NSSRG policy are given below.
0. The UDM stores the NSSRG slice selection policy to each subscribed S-NSSAI per access type. For example, the UDM stores information of the NSSRG per access type. For example, the UDM stores NSSRG information (or NSSRG policy) for 3GPP access and NSSRG information (or NSSRG policy) for non-3GPP access.

The NSSRG per access type can be interpreted based on at least two ways below:
The NSSRG defines Network Slice Simultaneous Registration Group to an access type and any S-NSSAI(s) in the Allowed NSSAI in another access type can coexist.
The NSSRG per access type can be interpreted that the NSSRG defines Network Slice Simultaneous Registration Group to an access type taking S-NSSAIs in the Allowed NSSAI in another access type into account if the UE (user equipment) has registered to the 5GS via another access type.

In one example, the NSSRG may be assigned to each subscribed S-NSSAI per combination of access type and VPLMN where the UE roams to.

In one example, the NSSRG may be assigned to each subscribed S-NSSAI per RAT type.
1. The UE does not have an NSSRG policy for an access type. The UE initiates the registration procedure to register to a PLMN via the access type. The UE constitutes S-NSSAI(s) to the Requested NSSAI in the Registration Request message based on the NSSP rule.
2. Upon reception of the Registration Request message, the AMF optionally performs authentication procedure. After completion of the authentication procedure, the AMF initiates security mode command procedure.
3. The AMF registers itself to the UDM for the UE by sending Nudm_UECM_Registration Request message. The Nudm_UECM_Registration Request message contains the access type and RAT type. For example, the Nudm_UECM_Registration Request message contains information indicating 3GPP access as the access type, and information indicating 5G (or NR) as the RAT type.
4. The AMF sends Nudm_SDM_GET Request (Nudm_SDM_GET_Req) message to the UDM to retrieve the UE subscription parameter(s) for the UE. For example, the UE subscription parameter for the UE includes the access type for the UE, and the RAT type for the UE. The UE subscription parameter(s) may be called as subscription information.
5. The UDM sends, to the AMF, Nudm_SDM_GET Response (Nudm_SDM_GET Rsp) message including NSSRG information corresponding to the access type or the RAT type based on the subscription information. The Nudm_SDM_GET Response message may include the UE subscription parameter(s) for the UE. As the AMF recognizes at least one of the access type and the RAT type based on the information in Nudm_UECM_Registration Request message, the AMF stores the NSSRG information per access type associated with each S-NSSAI in the UE context.

In one example the UDM also sends NSSRG information for another access type i.e. for an access type other than the current access type. In this case, Nudm_SDM_GET Response message contains the NSSRG policy together with an access type identifier which identifies the access type, as e.g. {(NSSRG policy 1, 3GPP access), (NSSRG policy 2, non-3GPP access)}. In this case, (NSSRG policy 1, 3GPP access) means that NSSRG policy 1 is for 3GPP access, and (NSSRG policy 2, non-3GPP access) means that NSSRG policy 2 is for non-3GPP access.
6. The AMF constitutes S-NSSAI(s) to the Allowed NSSAI based on the received NSSRG policy. If the Requested NSSAI includes S-NSSAIs which are not compatible, then the AMF accepts the S-NSSAIs which can be activated simultaneously and rejects the S-NSSAI which cannot be activated simultaneously with the Allowed NSSAI. The AMF sends Registration Accept message containing the Configured NSSAI, Allowed NSSAI and a rejected cause value per S-NSSAI indicating that the rejection is due to incompatible with S-NSSAI(s) in the Allowed NSSAI. The Registration Accept message also contains the NSSRG policy for the access type for the UE. The Registration Accept message optionally contains the NSSRG policy for another access type for the UE. The Registration Accept message may contain the NSSRG policy for the RAT type for the UE.

For example, if the Requested NSSAI includes S-NSSAI 1 and S-NSSAI 2 and the received NSSRG policy includes information indicating that S-NSSAI 1 and S-NSSAI 2 can be simultaneously provided to the UE (that is, the information indicates that S-NSSAI 1 and S-NSSAI 2 are included in same NSSRG), the AMF sends, to the UE, the Allowed NSSAI including S-NSSAI 1 and S-NSSAI 2.

For example, if the Requested NSSAI includes S-NSSAI 1 and S-NSSAI 2 and the received NSSRG policy includes information indicating that S-NSSAI 1 and S-NSSAI 3 can be simultaneously provided to the UE (that is, the information indicates that S-NSSAI 1 and S-NSSAI 3 are included in same NSSRG), the AMF sends, to the UE, the Allowed NSSAI including S-NSSAI 1 and a rejected cause value regarding S-NSSAI 2 to reject S-NSSAI 2.

In a case where the Registration procedure fails due to some reason, e.g. none of the S-NSSAI is set in the Allowed NSSAI, the network (e.g., AMF) sends, to the UE, Registration Reject message containing the NSSRG policy of the access type. In one example the NSSRG policy is sent in security protected Registration Reject message (that is, the message is integrity protected or ciphered or both). The Registration Reject message may not be security protected.

In one example the NSSRG policy can be sent in a NAS message during the network initiated deregistration procedure, e.g. the NSSRG policy is set in the deregistration request message. The AMF sends NSSRG policy during deregistration procedure when the network determines that the NSSRG policy in the UE is not the latest or receives a request from the UDM to update the NSSRG policy for the access type.

In another example the NSSRG policy per access type may be provided to the UE via the UE Configuration Update procedure. If the NSSRG policy per access type related to one or more network slices that the UE has already registered is changed based on changes in the UE subscription or as a result of operator's policy update, the AMF updates the NSSRG policy per access type for these network slice(s) in the UE via the UE Configuration Update procedure.

In one example the AMF sends NSSRG policy related to an access type other than the current access type. When the network (e.g. AMF) sends NSSRG policy of more than one access type, then the NSSRG policy is sent together with an access type identifier which identifies the access type, as e.g. {(NSSRG policy 1, 3GPP access), (NSSRG policy 2, non-3GPP access)}. In this case, (NSSRG policy 1, 3GPP access) means that NSSRG policy 1 is for 3GPP access, and (NSSRG policy 2, non-3GPP access) means that NSSRG policy 2 is for non-3GPP access.
7. When the UE receives Registration Accept message or Registration Accept message containing NSSRG policy. The UE stores the NSSRG policy for the access type. The UE sends Registration complete message to the AMF. When the UE receives Registration Accept message containing NSSRG policy for an access type other than the current access type, the UE stores the NSSRG policy for an access type other than the current access type.
8. The UE applies or enforces NSSRG policy when the UE constitutes Requested NSSAI in the Registration request message.

For example, the UE includes S-NSSAIs which can be allowed simultaneously in the Requested NSSAI of the Registration request message as per the NSSRG policy for the current access type. For example, the UE includes S-NSSAI 1 and S-NSSAI 2 in the Requested NSSAI of the Registration request message in a case where the NSSRG policy indicates that S-NSSAI 1 and S-NSSAI 2 can be allowed simultaneously.

The AMF may manage NSSRG policy per each access type level context. Table 1 shows an example of the UE context in the AMF. The UE context as defined in the Table 1 may be equally applicable to the UE context in the UE.

TABLE 1
UE context management example in First Aspect.
Per UE level context

| | |
|---|---|
| SUPI | subscriber's permanent identity |
| 5G-GUTI | 5G Globally Unique Temporary Identifier |

Per each access type level context

| | |
|---|---|
| NSSRG | NSSRG is maintained per each S-NSSAI(s) in |
| | the subscribed NSSAI. |

### <Second Aspect>

Second Aspect can solve, for example, the problem statement 1 and a problem statement 2 as shown below.

### <Problem Statement 2>

In roaming case the UE can be registered to a first VPLMN over 3GPP access and to a second VPLMN over non-3GPP access.

It is not clear how the UE and AMF enforce the NSSRG policy in a situation where the UE is registering to second VPLMN over non-3GPP access while the UE has been registered to a first VPLMN over 3GPP access.

In the second Aspect, when a UE is registered over a first PLMN via a first access type the AMF informs the Allowed NSSAI of the first access type to the UDM. The Allowed NSSAI of the first access type may be called as the Allowed NSSAI for the first PLMN.

When the UE is registering to access the second PLMN via second access type then the AMF fetches the Allowed NSSAI of the first access type from the UDM and compares the S-NSSAI(s) included in the Requested NSSAI with the S-NSSAI(s) included in the Allowed NSSAI for the first PLMN. If the S-NSSAI(s) in the Requested NSSAI is compatible with S-NSSAI(s) in the Allowed S-NSSAI(s) for the first PLMN then the Requested NSSAI is accepted and included in the Allowed NSSAI.

The detailed steps of registration procedure to different PLMNs via 3GPP access and non-3GPP access are described below.
0. The UE is registered to a VPLMN 1 via a first access type and the Allowed NSSAI 1 for the VPLMN 1 is stored in the UDM (or in other Network Function (NF), e.g. NSSF) during the registration procedure over VPLMN 1. The AMF 1 assigns 5G-GUTI 1 to the UE. The AMF 1 sends the Allowed NSSAI 1 during the registration procedure to the UDM. For example, the UE sends Allowed NSSAI 1 and the VPLMN 1 identity to the UDM 1 using one of the existing messages. For example, the AMF sends Allowed NSSAI 1 and the VPLMN 1 identity to the UDM I using one of the existing messages. The VPLMN 1 identity is an identity or an identifier for identifying the VPLMN 1.

The AMF may also send the Configured NSSAI 1 to the UDM. The VPLMN 1 identity may be an AMF identity, 5G-GUTI or combination on MCC and MNC. For example:
0-1. The AMF sends, to the UDM, Nudm_SDM_Info message including Allowed NSSAI for the VPLMN 1, Configured NSSAI for the VPLMN 1, VPLMN 1 identity after successful registration procedure.
0-2. The AMF sends, to the UDM, Nudm_UECM_Update message including Allowed NSSAI for the VPLMN 1, Configured NSSAI for the VPLMN 1, VPLMN 1 identity after successful registration procedure.
1. The UE initiates registration procedure to the VPLMN 2 via a second access type. The UE sends, to the VPLMN 2, Registration Request message containing a Requested NSSAI 2 of the VPLMN 2.
2. The AMF 2 optionally performs authentication and security mode command procedure.
3. The AMF registers itself to the UDM for the UE by sending Nudm_UECM_Registration Request message. The Nudm_UECM_Registration Request message contains the access type (e.g. the second access type) and RAT type. For example, the Nudm_UECM_Registration Request message contains information indicating the second access type, and information indicating the RAT type.
4. The AMF sends Nudm_SDM_GET Request (Nudm_SDM_GET Req) message to the UDM to retrieve the UE subscription parameter(s) for the UE. For example, the UE subscription parameter for the UE includes the access type for the UE, and the RAT type for the UE. The UE subscription parameter may be called as subscription information.
5. The UDM sends, to the AMF, Nudm_SDM_GET Response (Nudm_SDM_GET Rsp) message including the UE subscription parameter(s), the Allowed NSSAI 1 for the VPLMN 1 and the Configured NSSAI 1 for the VPLMN 1. The Allowed NSSAI 1 for the VPLMN 1 may be called as the Allowed NSSAI 1 of the VPLMN 1. The Configured NSSAI 1 for the VPLMN 1 may be called as the Configured NSSAI 1 of the VPLMN 1.
6. Upon reception of the Nudm_SDM_Get Response message containing the Allowed NSSAI 1 of VPLMN 1, the AMF 2 determines the Allowed NSSAI 2 of PLMN 2 based on the S-NSSAI(s) in the Allowed NSSAI 1 of the PLMN 1.

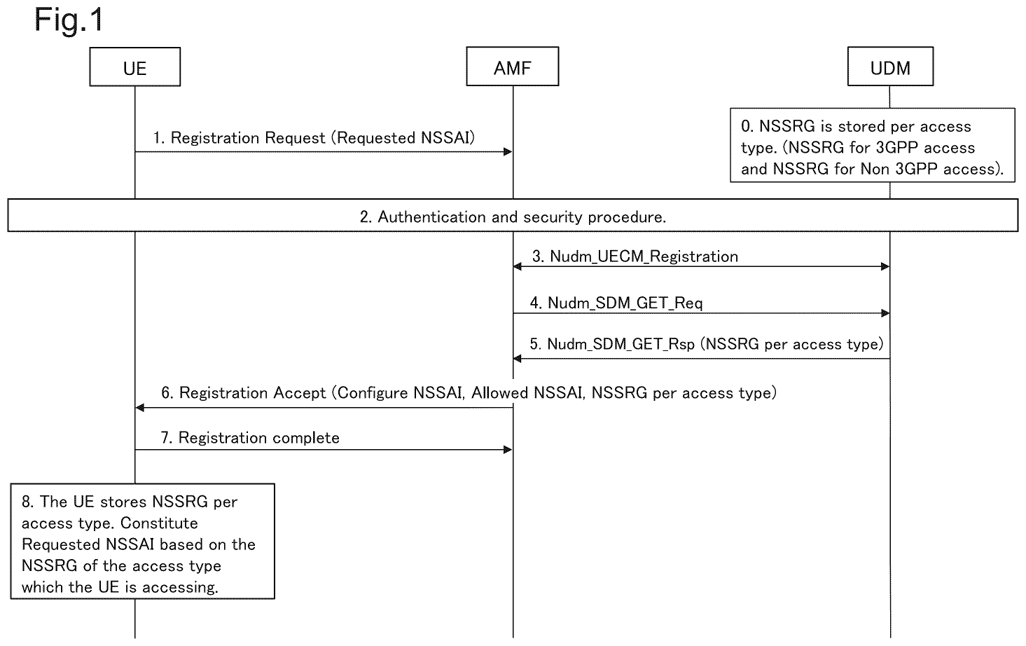

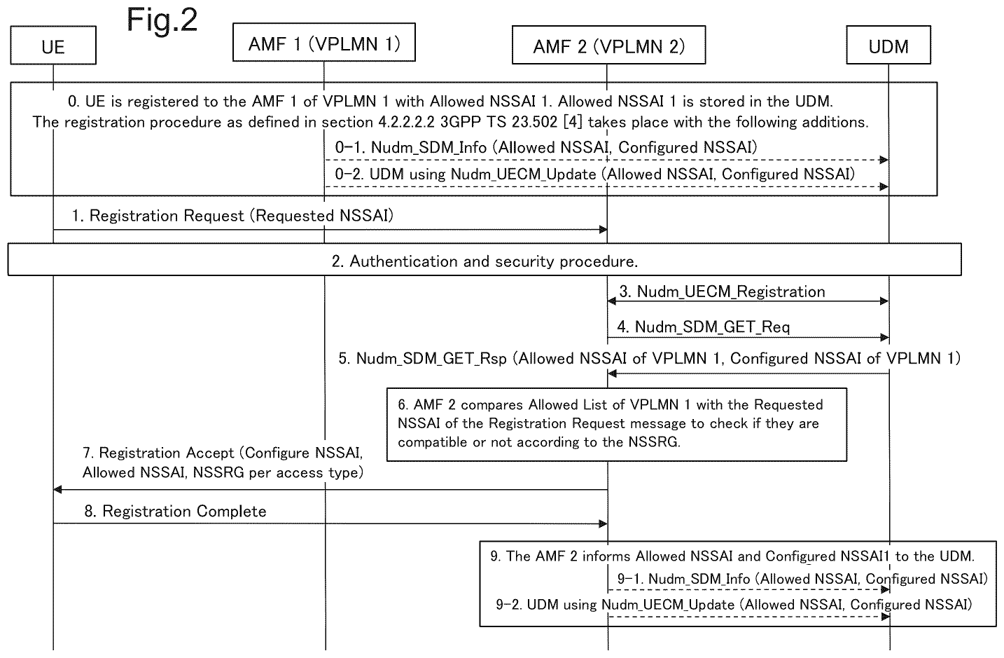

If the Allowed NSSAI 1 contains S-NSSAI 1 and the Requested NSSAI in step 1 contains S-NSSAI 1 and S-NSSAI 2, but S-NSSAI 1 and S-NSSAI 2 cannot be created (or allowed) simultaneously according to NSSRG policy then the AMF 2 includes only S-NSSAI 1 in the Allowed NSSAI 2 of the PLMN 2. The AMF 2 may obtain the NSSRG policy from the UDM. For example, the AMF 2 obtains the NSSRG policy in the steps 3 to 5 of the FIG. 2 in a same manner as steps 3 to 5 of the FIG. 1.

In case the Allowed NSSAI 1 is stored in another NF then the AMF fetches the Allowed NSSAI 1 from the NF. The NSSRG policy may be related to access type. For example, the NSSRG policy is related to either 3GPP access or non-3GPP access.
7. The AMF 2 sends Allowed NSSAI 2 and Configured NSSAI 2 of the VPLMN 2 to the UE in the Registration Accept message. In addition, the AMF may send the NSSRG information to the UE in the Registration Accept message.
8. Upon reception on the Registration Accept message containing Allowed NSSAI 2, the UE stores the Allowed NSSAI 2 for the VPLMN 2 and uses the Allowed NSSAI 2 in the NAS and AS procedure for the VPLMN 2. The UE sends Registration complete message to the AMF. The UE may use the received NSSRG information in the NAS and AS procedure for the VPLMN 2.
9. The AMF 2 sends the Allowed NSSAI 2 and optionally the Configured NSSAI 2 to the UDM in either step 9-1 or 9-2.
9-1. The AMF 2 sends, to the UDM, Nudm_SDM_Info message including the Allowed NSSAI 2 for the VPLMN 2, Configured NSSAI 2 for the VPLMN 2, and VPLMN 2 identity after the AMF 2 receives the Registration complete message from the UE.
9-2. The AMF sends, to the UDM, Nudm_UECM_Update message including Allowed NSSAI 2 for the VPLMN 2, Configured NSSAI 2 for the VPLMN 2, and VPLMN 2 identity after the AMF 2 receives the Registration complete message from the UE.

The VPLMN 2 identity is an identity or an identifier for identifying the VPLMN 2.

In this Aspect, the first access type is 3GPP access and the second access type is non-3GPP access respectively or vice versa. In this Aspect, the first access type and the second access type may be same access type.

### <First Variant of the Second Aspect>

In step 1, the UE may send the Allowed NSSAI 1 of the VPLMN 1 and the Requested NSSAI 2 in the Registration request message.

In step 6, the AMF 2 may use the Allowed NSSAI 1 that is received in the step 1 and calculate the Allowed NSSAI 2 for the VPLMN 2 as defined in the step 6.

### <Second Variant of the Second Aspect>

In step 1, the UE may send the 5G-GUTI 1 of the UE in the Registration Request message. During the registration procedure, the AMF 2 may fetch the Allowed NSSAI 1 from the AMF 1 by sending a first message containing 5G-GUTI 1 to the AMF 1. The AMF 1 may send the Allowed NSSAI 1 corresponding to the 5G-GUTI 1 to the AMF 2 in the second message. The first and second messages may be existing messages defined for communication between two AMFs or may be new messages.

In step 6, the AMF 2 may use the Allowed NSSAI 1 that is received in the step 1 and calculate the Allowed NSSAI 2 for the VPLMN 2 as defined in the step 6.

The AMF may manage NSSRG policy and VPLMN identity per each access type level context. Table 2 shows an example of the UE context in the AMF. The UE context as defined in the Table 2 may be equally applicable to the UE context in the UE.

TABLE 2
UE context management example in Second Aspect.
Per UE level context

| | |
|---|---|
| SUPI | subscriber's permanent identity |
| 5G-GUTI | 5G Globally Unique Temporary Identifier |

Per each access type level context

| | |
|---|---|
| NSSRG | NSSRG is maintained per each S-NSSAI(s) in |
| | the subscribed NSSAI. |
| Allowed NSSAI | Assigned allowed NSSAI to the UE over an access |
| | type. |
| VPLMN identity | A PLMN that the UE has registered in this access |
| | type. |

### <Third Aspect>

Third Aspect can solve, for example, the problem statement 1.

In the third Aspect, a UE is configured with a common NSSRG for any access types. The UE is registered over the first access type and an Allowed NSSAI of the first access type and Configured NSSAI of the first access type are assigned to the UE.

The UE gets a trigger to register for an S-NSSAI over second access type. The UE shall include only S-NSSAI(s) that belong to the NSSRG including at least one of the S-NSSAIs of the Allowed NSSAI of the first access type. In this Aspect, the first access type is 3GPP access and the second access type is non-3GPP access respectively or vice versa. The first access type and the second access type are always different. This Aspect can be applicable for a case where a UE has been registered over the first access type with PLMN 1 and is performing registration procedure over the second access type with PLMN 2. In all variants of this aspect, the received NSSRG policy over an access type is applicable for both first access type and second access type.

The detailed steps of the procedure is defined as below.
0. The UE has performed a registration procedure and the UE has registered to a PLMN 1 via a first access type and the UE is assigned an Allowed NSSAI 1 for the PLMN 1 and Configured NSSAI 1 for the PLMN 1 by the PLMN 1. The Allowed NSSAI 1 may be related to the first access type. The Configured NSSAI 1 may be related to the first access type. The UE is also configured with NSSRG information. The NSSRG information may be related to the PLMN 1. The NSSRG information may be related to the first access type. The UE may receive the NSSRG information from an AMF of the PLMN 1 during a registration procedure for the PLMN 1.

For example, the UE receives the Allowed NSSAI 1, the Configured NSSAI 1 and the NSSRG information of the first access type for the PLMN 1 by receiving the Registration Accept message in a same manner as the step 6 in FIG. 1. In addition, the AMF may receive the NSSRG information from the UDM in a same manner as the steps 4 and 5 in FIG. 1. In addition, the AMF may constitute (or determined) the Allowed NSSAI including S-NSSAI(s) based on the NSSRG information in a same manner as the step 6 in FIG. 1.
1. The UE receives a request, from the upper layer, to trigger registration procedure for the S-NSSAI 1 over (or via) the second access type to the same PLMN. The UE checks if the S-NSSAI 1 shares a common NSSRG with all S-NSSAI(s) in the Allowed NSSAI 1 by using the NSSRG information of the first access type for the PLMN 1. The UE performs either step 2a or 2b depending of an outcome of the check.
2a. If the S-NSSAI 1 shares a common NSSRG with all S-NSSAI(s) in the Allowed NSSAI 1, then the UE shall initiate registration procedure by sending Registration Request message containing S-NSSAI 1 in the Requested NSSAI. The UE sends the Registration Request message via the second access type.

Upon receiving the Registration Request message, on the basis of the NSSRG information, the AMF shall check if the S-NSSAI 1 shares a common group with all S-NSSAI present in the allowed NSSAI 1. If this is true then the AMF includes S-NSSAI 1 as Allowed NSSAI in the Registration Accept message, according to the registration procedure, otherwise the AMF shall reject the S-NSSAI 1 with cause value that the slice is not compatible with the Allowed NSSAI of the first access type. The Allowed NSSAI included in the Registration accept message is related to the second access type.
2b If the S-NSSAI 1 does not share a common NSSRG with the S-NSSAIs in the Allowed NSSAI 1 of the first access type then the UE shall not send Registration Request message with S-NSSAI 1.

### Examples of the Third Aspect

Example i. UE has Configured NSSAI and information of NSSRG and Allowed NSSAI.

The Configured NSSAI includes S-NSSAI A, S-NSSAI B and S-NSSAI C. The NSSRG includes two groups such as {S-NSSAI A, S-NSSAI B} and {S-NSSAI B, S-NSSAI C}. That is, in this case, the S-NSSAI A and the S-NSSAI B belong to first group, and the S-NSSAI B and the S-NSSAI C belong to second group. Allowed NSSAI 1 includes S-NSSAI A.

For example, the UE receives a request, from the upper layer, to trigger registration procedure for the S-NSSAI B or the S-NSSAI A over the second access type. In this case, the UE checks if the S-NSSAI B or the S-NSSAI A shares a common NSSRG with the S-NSSAI A in the Allowed NSSAI 1.

In this case, the S-NSSAI A and the S-NSSAI B belong to the first group, hence the UE determines that the S-NSSAI B or the S-NSSAI A which the upper layer requests shares a common NSSRG with the S-NSSAI A in the Allowed NSSAI 1. Then the UE sends a Registration Request message including a Requested NSSAI set to the S-NSSAI B or the S-NSSAI A.

In other words, the UE checks if S-NSSAI which the upper layer requests (that is, the S-NSSAI which can be set to Requested NSSAI) and S-NSSAI(s) in the Allowed NSSAI belong to same NSSRG. If the S-NSSAI which the upper layer requests and S-NSSAI(s) in the Allowed NSSAI belong to same NSSRG, the UE sends a Registration Request message including Requested NSSAI set to the S-NSSAI which the upper layer requests.

Further in other words, the UE checks whether S-NSSAI which the upper layer requests (that is, the S-NSSAI which can be set to Requested NSSAI) is included in NSSRG including S-NSSAI(s) in the Allowed NSSAI. If the S-NSSAI which the upper layer requests is included in the NSSRG, the UE sends a Registration Request message including Requested NSSAI set to the S-NSSAI which the upper layer requests.

In addition, the AMF also checks if the S-NSSAI B or the S-NSSAI A in the Requested NSSAI of the Registration Request message shares a common NSSRG with the S-NSSAI A in the Allowed NSSAI 1 in a same manner as the UE. In this case, the S-NSSAI A and the S-NSSAI B belong to the first group, hence the AMF also determines that the S-NSSAI B or the S-NSSAI A in the Requested NSSAI shares a common NSSRG with the S-NSSAI A in the Allowed NSSAI 1. Then the AMF includes the S-NSSAI B or S-BSSAI A as the Allowed NSSAI in the Registration Accept message, and sends the Registration Accept message to the UE.

That is, if the Requested NSSAI over the second access type is S-NSSAI B or S-NSSAI A, then registration procedure is allowed to initiate over the second access.

For example, the UE receives a request, from the upper layer, to trigger registration procedure for the S-NSSAI C over the second access type. In this case, the UE checks if the S-NSSAI C shares a common NSSRG with the S-NSSAI A in the Allowed NSSAI 1.

In this case, the S-NSSAI C belongs to the second group, hence the UE determines that the S-NSSAI C which the upper layer requests does not share a common NSSRG with the S-NSSAI A in the Allowed NSSAI 1. Then the UE does not send a Registration Request message including a Requested NSSAI set to the S-NSSAI C.

That is, if the Requested NSSAI over the second access type is S-NSSAI C then registration procedure is not allowed to initiate over the second access.

Example ii. UE has Configured NSSAI and information of NSSRG and Allowed NSSAI. The Configured NSSAI includes S-NSSAI A, S-NSSAI B, S-NSSAI C and S-NSSAI D. The NSSRG includes three groups such as {S-NSSAI A, S-NSSAI B}, {S-NSSAI B, S-NSSAI C} and {S-NSSAI A, S-NSSAI B, S-NSSAI C} That is, in this case, the S-NSSAI A and the S-NSSAI B belong to first group, and the S-NSSAI B and the S-NSSAI C belong to second group, and the S-NSSAI A, S-NSSAI B and the S-NSSAI C belong to third group. Allowed NSSAI 1 includes S-NSSAI A and S-NSSAI B.

For example, the UE receives a request, from the upper layer, to trigger registration procedure for the S-NSSAI C over the second access type. In this case, the UE checks if the S-NSSAI C shares a common NSSRG with the S-NSSAI A and the S-NSSAI B in the Allowed NSSAI 1.

In this case, the S-NSSAI A, the S-NSSAI B and the S-NSSAI C belong to the third group, hence the UE determines that the S-NSSAI C which the upper layer requests shares a common NSSRG with the S-NSSAI A and the S-NSSAI B in the Allowed NSSAI 1. Then the UE sends a Registration Request message including a Requested NSSAI set to the S-NSSAI C.

In addition, the AMF also checks if the S-NSSAI C shares a common NSSRG with the S-NSSAI A and the S-NSSAI B in the Allowed NSSAI 1 in a same manner as the UE. In this case, the S-NSSAI A, the S-NSSAI B and the S-NSSAI C belong to the third group, hence the AMF also determines that the S-NSSAI C in the Requested NSSAI shares a common NSSRG with the S-NSSAI A and the S-NSSAI B in the Allowed NSSAI 1. Then the AMF includes the S-NSSAI C as the Allowed NSSAI in the Registration Accept message, and sends the Registration Accept message to the UE.

That is, if the Requested NSSAI over the second access type is S-NSSAI C then registration procedure is allowed to initiate over second access.

For example, the UE receives a request, from the upper layer, to trigger registration procedure for the S-NSSAI D over the second access type. In this case, the UE checks if the S-NSSAI D shares a common NSSRG with the S-NSSAI A and the S-NSSAI B in the Allowed NSSAI 1.

In this case, the S-NSSAI D does not belong to any groups, hence the UE determines that the S-NSSAI D which the upper layer requests does not share a common NSSRG with the S-NSSAI A and the S-NSSAI B in the Allowed NSSAI 1. Then the UE does not send a Registration Request message including a Requested NSSAI set to the S-NSSAI D.

That is, if the Requested NSSAI over the second access type is S-NSSAI D then registration procedure is not allowed to initiate over second access.

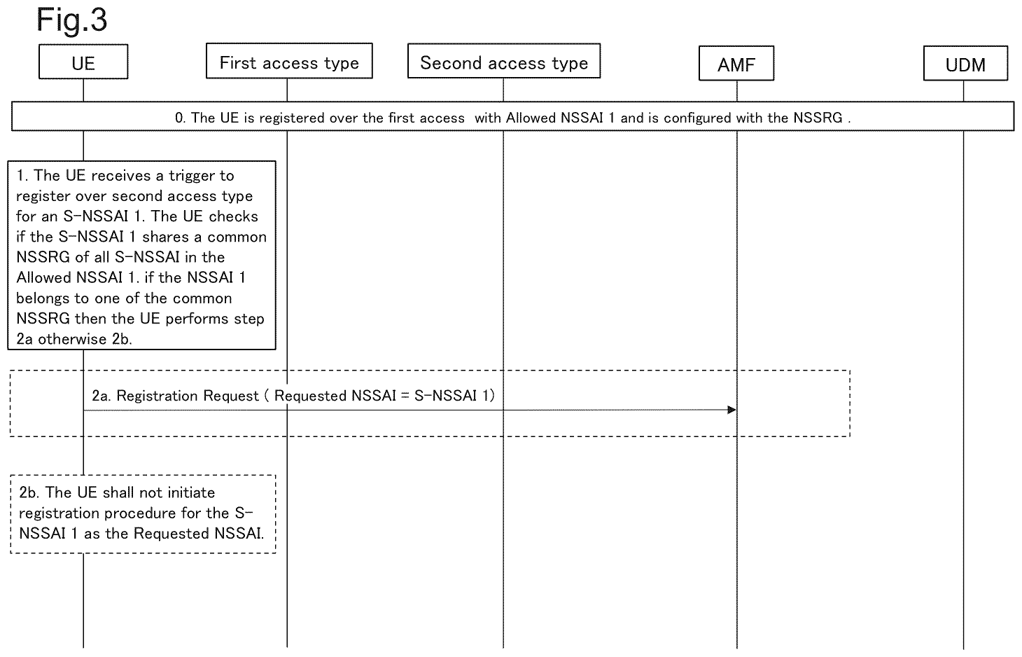

In addition, for example, the steps 1, 2a and 2b in FIG. 3 may be performed after step 7 in FIG. 1. For example, when the UE is registered over the first access in steps 1 to 7 of FIG. 1 and the UE performs a registration procedure over the second access, the UE may perform step 1 in FIG. 3 based on the NSSRG information of the first access. Then the UE performs step 2a or step 2b in FIG. 3.

In addition, for example, the steps 1, 2a and 2b in FIG. 3 may be performed after step 8 in FIG. 2. For example, when the UE is registered over the second access in steps 1 to 8 of FIG. 1 and the UE performs a registration procedure over the first access, the UE may perform step 1 in FIG. 3 based on the NSSRG information of the second access. Then the UE performs step 2a or step 2b in FIG. 3.

### <First Variant of the Third Aspect>

If the S-NSSAI 1 does not share a common NSSRG with the S-NSSAI(s) of the Allowed NSSAI 1 then the UE shall not send Registration Request message with S-NSSAI 1, then the UE may perform deregistration procedure over the first access. After the deregistration procedure over the first access the UE shall initiate registration procedure over the second access and send a Registration Request message containing S-NSSAI 1 in the Requested NSSAI.

### <Second Variant of the Third Aspect>

The UE and the network (e.g. AMF) enforce NSSRG policy independently for the first access and second access for the UE. When the UE initiates registration procedure over the second access while the UE is registered over the first access then the UE shall not check whether Requested NSSAI over the second access shares a common NSSRG of the Allowed NSSAI of the first access type. In this case, the AMF may check whether Requested NSSAI over the second access shares a common NSSRG of the Allowed NSSAI of the first access type. In addition, the AMF may obtain the NSSRG information of the first access type for the PLMN 1 to check whether Requested NSSAI over the second access shares a common NSSRG of the Allowed NSSAI of the first access type. For example, the AMF obtains the NSSRG information of the first access type for the PLMN 1 from the UDM in a same manner as the steps 4 and 5 in FIG. 1.

The AMF may manage NSSRG policy per UE level context. Table 3 shows an example of the UE context in the AMF. The UE context as defined in the Table 3 may be equally applicable to the UE context in the UE.

TABLE 3
UE context management example in Third Aspect.
Per UE level context

| | |
|---|---|
| SUPI | subscriber's permanent identity |
| 5G-GUTI | 5G Globally Unique Temporary Identifier |
| NSSRG | NSSRG is maintained per each S-NSSAI(s) in |
| | the subscribed NSSAI. |

### <Third Variant of the Third Aspect>

In step 0, the network (e.g. AMF) sends a configuration parameter e.g. NSSRG access type priority. For example, configuration parameter is sent to the UE. The configuration parameter indicates whether the first access or the second access has the higher priority to continue the ongoing NAS procedure. For example, the configuration parameter indicates whether the first access or the second access has the higher priority to continue the ongoing NAS procedure if the UE is registered over first access and has an allowed NSSAI and the requested NSSAI for the second access type does not share a common NSSRG with the Allowed NSSAI over the first access. This configuration parameter is sent in an existing NAS message or a new NAS message during a NAS procedure (e.g. Registration accept message of registration procedure, or Configuration Update command message during generic configuration update command procedure). The network (e.g. AMF) may send the configuration parameter regardless of a registration status of the UE in 3GPP access or non-3GPP access. The AMF may obtain the configuration parameter from the UDM as a subscriber data.

In steps 1 and 2, when the UE receives a trigger to register for the S-NSSAI 1 over the second access if the configuration parameter indicates that the second access has higher priority than the first access and the S-NSSAI 1 does not share a common NSSRG with the S-NSSAIs of the allowed NSSAI 1 of the first access type, the UE sends registration request message containing the S-NSSAI 1 in the requested NSSAI. If the configuration parameter indicates the first access has higher priority than the second access type then the UE shall not send the registration request message containing the S-NSSAI 1 in the requested NSSAI to the network. Once the UE has allowed NSSAI for the second access type, the UE may initiate other NAS procedure for the S-NSSAI(s) in the allowed NSSAI e.g. PDU session establishment related to the allowed NSSAI or service request procedure.

The UE or the AMF may release the N1 signaling connection over the first access if the second access has higher priority. The UE may trigger a registration request message over the first access containing the S-NSSAI belonging to the common NSSRG of the S-NSSAI of the requested NSSAI of the second access. In one example, the UE initiates a NAS signaling over the second access only after the UE or the network releases the N1 signaling connection over the first access, or the UE or the network puts S-NSSAI(s) that does not belong to the common NSSRG with the allowed NSSAI for the second access type to the rejected NSSAI over the first access or the UE or the network deregisters the UE over the first access.

### <Fourth Variant of the Third Aspect>

The 3GPP access has always the higher priority than the non-3GPP access. In step 1, if the first access is non-3GPP access then the UE may send registration request message over the 3GPP access containing the S-NSSAI 1 in the requested NSSAI. The UE or the AMF may release the N1 signaling connection over the non-3GPP access, or the UE or the network may put S-NSSAI(s) that does not belong to the common NSSRG with the allowed NSSAI for the 3GPP access type to the rejected NSSAI over the non-3GPP access type or may deregister the UE over the non-3GPP access.

### <Fifth Variant of the Third Aspect>

The UE or the AMF processes the registration request message if the S-NSSAI(s) in the requested NSSAI over the second access does not share the common NSSRG with S-NSSAI(s) of the allowed NSSAI of the first access when there is no PDU session or no DRB is established for the first access type. Once the UE has allowed NSSAI for the second access type, the UE may initiate other NAS procedure for the S-NSSAI(s) in the allowed NSSAI e.g. PDU session establishment related to the allowed NSSAI or service request procedure.

In one example in step 1, the UE sends registration request message containing the S-NSSAI 1 as the requested over the second access type if the UE has no PDU session or no DRB for the first access type otherwise the UE shall wait for the PDU session or DRB to be released for the first access type and then sends registration request message containing the S-NSSAI 1.

### <Sixth Variant of the Third Aspect>

In step 0, during the registration procedure in a NAS message (e.g. registration accept message) or in a NAS message during a NAS procedure, the AMF sends a configuration parameter indicating whether the UE can initiate registration procedure for a requested NSSAI over the second access type if the S-NSSAI(s) of the requested NSSAI does not share the common NSSRG with S-NSSAI(s) of the Allowed S-NSSAI of the first access type.

In steps 1 and 2, if the configuration parameter indicates that the UE is allowed to send a requested NSSAI over the second access type if the S-NSSAI(s) of the requested NSSAI does not share the common NSSRG with the S-NSSAI(s) of the allowed NSSAI then the UE shall initiate registration procedure for the requested NSSAI over the second access type, otherwise the UE shall not initiate registration procedure over the second access with the requested NSSAI. Once the UE has allowed NSSAI for the second access type, the UE may initiate other NAS procedure for the S-NSSAI(s) in the allowed NSSAI e.g. PDU session establishment related to the allowed NSSAI or service request procedure.

In one example, the Allowed NSSAI of the first access type includes S-NSSAI 1 and requested NSSAI over the second access type is S-NSSAI 2. If the S-NSSAI 2 does not share common NSSRG with the S-NSSAI 1 and the UE configuration parameter indicates the UE is allowed to initiate registration over the second access type if the requested NSSAI(s) does not share common NSSRG of the allowed NSSAI(s) over the first access type, then the UE shall initiate registration procedure over the second access type with requested NSSAI set to S-NSSAI 2. Otherwise the configuration parameter does not allow this, the UE shall not initiate the registration request procedure over the second access type with the requested NSSAI set to S-NSSAI 2.

In one example, the UE may initiate all the NAS procedure over the second access type (e.g. service request procedure) if the configuration parameter allows the UE to initiate the registration procedure over the second access type if the allowed NSSAI of the first access doesn't share the common NSSRG with the requested NSSAI or allowed NSSAI over the second access type.

### <Seventh Variant of the Third Aspect>

Each access applies the NSSRG policy independently on their NAS or AS procedure. The UE and the network apply the NSSRG policy on allowed NSSAI or requested NSSAI of one access type independent of the allowed or requested NSSAI of another access type i.e. the requested NSSAI or allowed NSSAI of a second access type does not depend on the allowed or requested NSSAI of the first access type in case where the NSSRG policy is sent to the UE and this NSSRG policy applies for both access. It means that although there is a common NSSRG per UE applicable to both 3GPP access type and non-3GPP access type, each access type has its own NSSRG management (e.g. its own NSSRG policy) and disregards to a NSSRG management in another access type (e.g. NSSRG policy in another access type).

For example, the UE has configured S-NSSAI 1 and S-NSSAI 2. The NSSRG policy is {S-NSSAI 1} and {S-NSSAI 2}, the UE may send Registration request message containing S-NSSAI 2 in the requested NSSAI over the second access type if the allowed NSSAI of the first access type is {S-NSSAI 1}. The network (e.g. AMF) can accept the S-NSSAI 2 as allowed NSSAI for the second access type.

### <Eighth Variant of the Third Aspect>

In step 2a, if the network (e.g. AMF) receives the registration request message from the UE with the S-NSSAI 1 in requested NSSAI over the second access type wherein the received S-NSSAI 1 cannot co-exist with S-NSSAI(s) in the allowed NSSAI of the first access type according to the common NSSRG rule for both access types, then the network (e.g. AMF) accepts the S-NSSAI 1 of the second access type. In this case, the network (e.g. AMF) sends the registration accept message to the UE including the S-NSSAI 1 to the allowed NSSAI for the second access type and new parameter rejected NSSAI with other access type that includes all incompatible S-NSSAI(s) in the first access type to the S-NSSAI 1. Upon reception of the registration accept message, the UE updates the allowed NSSAI and Rejected NSSAI in the UE. Alternatively, the network (e.g. AMF) initiates the separate configuration update command procedure to update the new allowed NSSAI or/and rejected NSSAI over the first access type by sending the Configuration Update Command message containing the allowed NSSAI and rejected NSSAI based on a result of the registration management procedure over the second access type.

Example, UE is configured with slice S-NSSAI A, S-NSSAI B and S-NSSAI C. The NSSRG policy includes compatible slice {S-NSSAI A, S-NSSAI B} and {S-NSSAI B, S-NSSAI C}. The UE is registered over the first access type with allowed NSSAI={S-NSSAI A, S-NSSAI B}. The UE sends registration request message over the second access type containing Request NSSAI set to S-NSSAI C. The network upon reception of the registration request message, accepts the requested NSSAI and sends Registration accept message containing Allowed NSSAI set to S-NSSAI C. The network sends Configuration update command procedure with allowed NSSAI set to S-NSSAI B and rejected NSSAI set to S-NSSAI A with reason that the slice can't co-exist or not compatible with allowed NSSAI as per the NSSRG policy. For example, the network sends Configuration update command procedure with allowed NSSAI of the first access type set to S-NSSAI B and rejected NSSAI set to S-NSSAI A with reason that the slice can't co-exist or not compatible with allowed NSSAI as per the NSSRG policy.

### <Ninth Variant of the Third Aspect>

In step 2b, if the network (e.g. AMF) receives the registration request message from the UE with the S-NSSAI 1 in requested NSSAI over the second access type wherein the received S-NSSAI 1 cannot co-exist with S-NSSAI(s) in the allowed NSSAI of the first access type according to the common NSSRG rule for both access types, then the network (e.g. AMF) rejects the registration procedure by sending a registration reject message containing a cause indicating the UE to register over the second access with S-NSSAI sharing common NSSRG with allowed NSSAI over the first access type. The UE on receiving the Registration reject message may send registration request message over the second access type containing the requested NSSAI set to only S-NSSAI(s) compatible with S-NSSAI(s) of the allowed NSSAI of the first access type.

Alternatively, the UE on receiving the Registration reject message may send the registration request message over the first access type without containing the request NSSAI set to the S-NSSAI(s) that are incompatible with S-NSSAI(s) that were set to the requested NSSAI in the registration request message over the second access type. I.E., the UE removes all incompatible S-NSSAI(s) from the allowed NSSAI over the first access type. After the successful registration procedure over the first access type, then the UE re-initiates the registration procedure again over the second access type.

### <Tenth Variant of the Third Aspect>

In step 1, the UE may send registration request over the second access containing the requested NSSAI if the S-NSSAI in the requested NSSAI has higher priority than the S-NSSAI(s) of the allowed NSSAI over the first access type when the S-NSSAI of the requested NSSAI does not share the common NSSRG of the allowed NSSAI of the first access. Priority of the S-NSSAI (s) can be configured by the network (e.g. AMF) or the UE determines the priority of the S-NSSAI(s) e.g. if a first application mapping to a first S-NSSAI has a higher priority over a second application mapping to a second S-NSSAI then the first S-NSSAI has higher priority than the second S-NSSAI.

### <Fourth Aspect>

Fourth Aspect can solve, for example, a problem statement 3 as shown below.

### <Problem Statement 3>

When the UE performs the Registration procedure, an assigned AMF for the UE may be changed to another one (that is, another AMF) due to various reasons. For example, the reason is long distance UE movement, lack of support for new S-NSSAI in the Requested NSSAI from the UE, etc.

In this case, it is not clear how the new AMF obtains the NSSRG information as new AMF may not always download the subscriber data from the UDM in every single registration procedure.

In the Fourth Aspect, an AMF stores the NSSRG information in the UE context. If the registration procedure requires an AMF change, then an old AMF transfers the NSSRG information to a new AMF so that the new AMF can generate an Allowed NSSAI taking the NSSRG information into account.

The detailed steps of the procedure is defined as below.
0. The UE is registered with an old AMF. The old AMF maintains the Configured NSSAI, subscribed NSSAI, the UE registered S-NSSAI(s) and the NSSRG information for each S-NSSAI in the UE context.
1. When the UE initiates registration procedure by sending the Registration Request message including 5G-GUTI to 5GC via an access network, the access network chooses a new AMF. For example, if the old AMF does not cover new UE location, the access network chooses the new AMF. For example, the Registration Request message includes Requested NSSAI.
2. The new AMF sends Namf_Communication_UEContextTransfer message including the 5G-GUTI to the old AMF in order to obtain UE context for the UE. The old AMF may be found based on the 5G-GUTI.
3. The old AMF finds the UE context for the UE based on the received 5G-GUTI and sends, to the new AMF, Namf_Communication_UEContextTransfer response message including NSSRG information. The old AMF may include Allowed NSSAI, Configured NSSAI and subscribed NSSAI in the Namf_Communication_UEContextTransfer response message. For example, the old AMF sends the NSSRG information in response to reception of the Namf_Communication_UEContextTransfer message. In addition, for example, the old AMF finds the NSSRG information corresponding to the 5G-GUTI, and sends the NSSRG information to the new AMF.
4. Once the new AMF receives the NSSRG information, the new AMF generates an Allowed NSSAI taking the received NSSRG information into account. The new AMF proceeds the registration procedure with the step 6 in section 4.2.2.2.2 of NPL 4. For example, the Requested NSSAI in the Registration Request message is S-NSSAI 1 and the received NSSRG information includes information indicating that NSSRG comprises S-NSSAI 1 and S-NSSAI 2, the new AMF generates the Allowed NSSAI including S-NSSAI 1 and S-NSSAI 2.

### <First Variant of the Fourth Aspect>

If the UE has registered to another access type with the same AMF, i.e., the UE is registered to both 3GPP access and non-3GPP access with a single PLMN, the old AMF may include an Allowed NSSAI that has been assigned to the UE for another access type to the Namf_Communication_UEContextTransfer response message in step 3. For example, if the UE has registered to first access type (e.g. 3GPP access) with the new AMF and the UE performs a registration procedure to the new AMF via second access type (e.g. non-3GPP access), the old AMF may include an Allowed NSSAI that has been assigned to the UE for the first access type to the Namf_Communication_UEContextTransfer response message in step 3.

In this case, the new AMF generates an Allowed NSSAI taking the S-NSSAI(s) assigned to another access type for the UE into account. For example, the new AMF generates an Allowed NSSAI of the second access type taking the S-NSSAI(s) in the Allowed NSSAI of the first access type for the UE into account. For example, the new AMF generates the Allowed NSSAI of the second access type which includes at least one of the S-NSSAIs in the Allowed NSSAI of the first access type.

The AMF may manage NSSRG policy per UE level context. Table 4 shows an example of the UE context in the AMF. The UE context as defined in the Table 4 may be equally applicable to the UE context in the UE.

TABLE 4
UE context management example in Fourth Aspect.
Per UE level context

| | |
|---|---|
| Subscribed NSSAI | Downloaded subscribed NSSAI from the UDM. |
| Configured NSSAI | Assigned configured NSSAI to the UE. |
| NSSRG | NSSRG is maintained per each S-NSSAI(s) in |
| | the subscribed NSSAI. |

Per each access type level context

| | |
|---|---|
| Allowed NSSAI | Assigned allowed NSSAI to the UE over an access |
| | type. |

### <Fifth Aspect>

Fifth Aspect can solve, for example, a problem statement 4 as shown below.

### <Problem Statement 4>

When a handover for the UE is performed, it is not clear how the RAN node takes the NSSRG information into account for the handover.

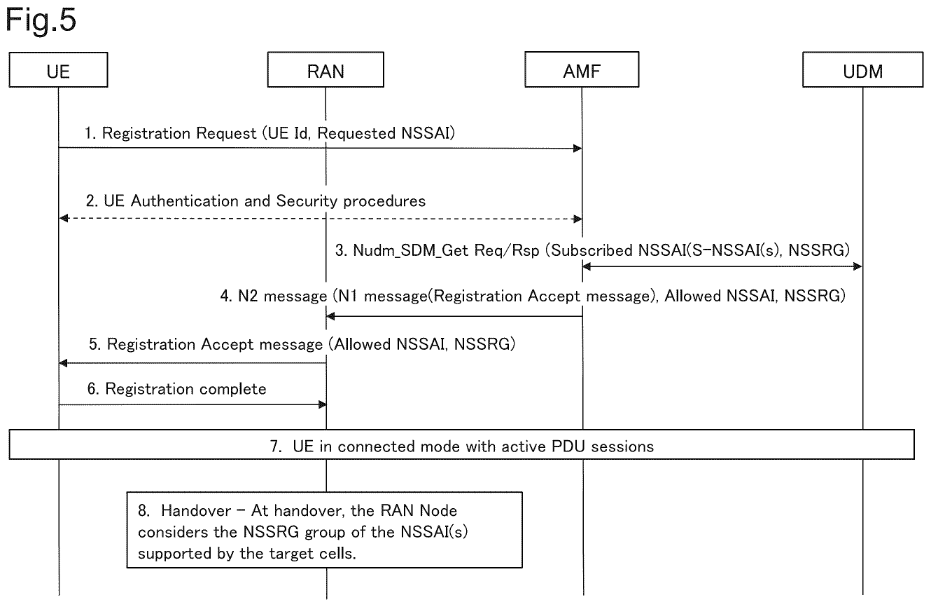

In the fifth Aspect, for service continuity, at mobility via handover the source RAN (Radio Access Network) shall consider the NSSRG affiliation of the network slices supported by the target cells, as shown in FIG. 5.

The NSSRG affiliation of the network slices supported by the target cells may be called as NSSRG information of the target cells.
1. A UE requests registration with the network and the UE provides its UE Identity (or UE Id or UE identifier) and the Requested NSSAI along with the rest of the required parameters. For example, the UE sends a Registration Request message including the UE Id and the Requested NSSAI.
2. The network and the UE successfully run the UE authorization and UE security procedures.
3. The AMF retrieves the UE subscription information from the UDM along with the NSSRG information for the network slice(s) which the UE has requested to register for.

For example, the AMF sends Nudm_SDM_GET Request (Nudm_SDM_GET_Req) message to the UDM to retrieve the UE subscription parameter(s) for the UE. The UDM sends, to the AMF, Nudm_SDM_GET Response (Nudm_SDM_GET Rsp) message including the UE subscription information and NSSRG information for the network slices which the UE has requested to register for. For example, the Nudm_SDM_GET Request message may include information indicating the network slice(s) which the UE has requested to register for (e.g. S-NSSAI), then the UDM may chose or select appropriate NSSRG information based on the information indicating the network slice(s), and send the NSSRG information to the AMF. For example, the UDM may chose or select NSSRG information indicating that NSSRG comprises at least one of the network slice(s) which the UE has requested to register for.

The AMF constructs the Allowed NSSAI for the UE so that each of the S-NSSAI(s) in the Allowed NSSAI shares at least one NSSRG between them. For example, the AMF constructs the Allowed NSSAI so that the S-NSSAI(s) in the Allowed NSSAI is included in a same NSSRG. In addition, the Allowed NSSAI may include S-NSSAI included in the Requested NSSAI in step 1.
4. The AMF provides the S-NSSAI(s) in the Allowed NSSAI and their NSSRG affiliation to the RAN Node in the N2 Request message or in any other NGAP message between the AMF and the RAN. The AMF may also provide the NSSRG information within the CN Assistance Information element.
5 The network confirms the UE registration with the Registration Accept message including Allowed NSSAI and the NSSRG information for each S-NSSAI(s) in the Allowed NSSAI.
6. The UE sends Registration complete message to the AMF.
7. Due to an activity in an application in the UE an upper layer requests the UE to send uplink packet to the network or downlink packet arrived to the UE, the UE becomes to a connected mode with active PDU Sessions. The RAN Node may receive the Allowed NSSAI and their NSSRG affiliation and the NSSRG information for each S-NSSAI(s) in the Allowed NSSAI included in the N2 message when the radio bearers are established.
8. When a handover is required, the RAN Node takes into account the NSSRG affiliation of the network slices supported in the qualifying target cells:
In X2 and N2 handover, if the source RAN Node does not find another cell supporting the network slice with active PDU sessions, the source RAN Node shall select a target cell supporting a network slice on which the active PDU session can be maintained and which is of the same NSSRG affiliation as the current network slice with active PDU Sessions on it. In X2 handover, the source RAN Node can retrieve the target RAN's supported network slices information and the NSSRG information regarding the network slice(s) supported in the target RAN (that is, NSSRG information regarding the target RAN) via the X2 interface.

For example, when the handover is performed, the source RAN Node may retrieve the NSSRG information regarding the network slice(s) supported in the target RAN via the X2 interface. For example, based on the NSSRG information received in step 4 (that is, NSSRG information regarding the source RAN) and the NSSRG information regarding the target RAN, the source RAN Node may select a target cell of the target RAN which has same NSSRG to the NSSRG of the source RAN.
In inter-PLMN Handover, the source RAN Node shall select a target cell supporting the same network slice only if they are of the same NSSRG affiliation. Otherwise the RAN Node may select a target cell supporting another network slice on which the active PDU session can be maintained and which is of the same NSSRG affiliation. In inter-PLMN Handover, the source RAN Node can retrieve the target RAN's supported network slices information and the NSSRG information regarding the network slice(s) supported in the target RAN (that is, NSSRG information regarding the target RAN) via the N2 interface. For example, when the handover is performed, the source RAN Node may retrieve the NSSRG information regarding the network slice(s) supported in the target RAN via the N2 interface. For example, based on the NSSRG information received in step 4 (that is, NSSRG information regarding the source RAN) and the NSSRG information regarding the target RAN, the source RAN Node may select a target cell of the target RAN which has same NSSRG to the NSSRG of the source RAN.

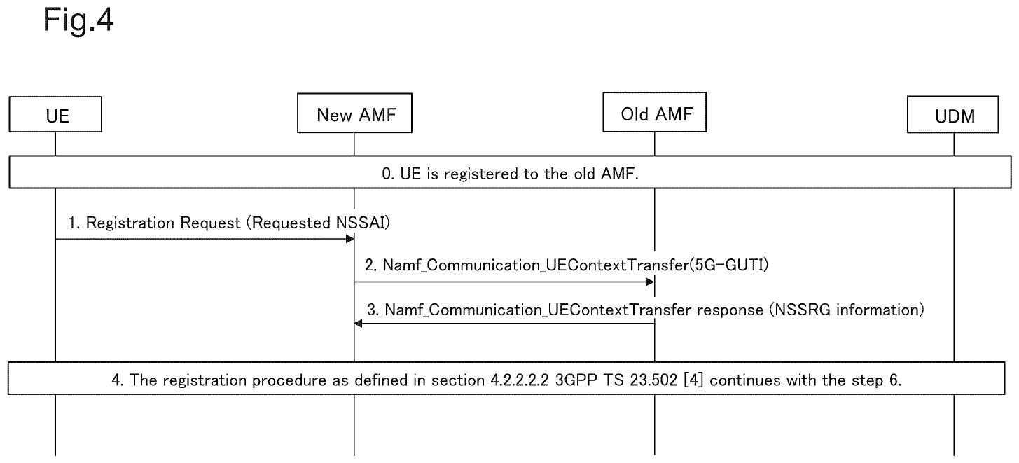

The steps 7 and 8 in FIG. 5 may be performed after the step 8 in FIG. 1, or after the step 8 in FIG. 2, or the step 2a in FIG. 3, or after the step 4 in FIG. 4.

The above described aspects solve problem how the NSSRG needs to be handled in some situations.

### <System Overview>

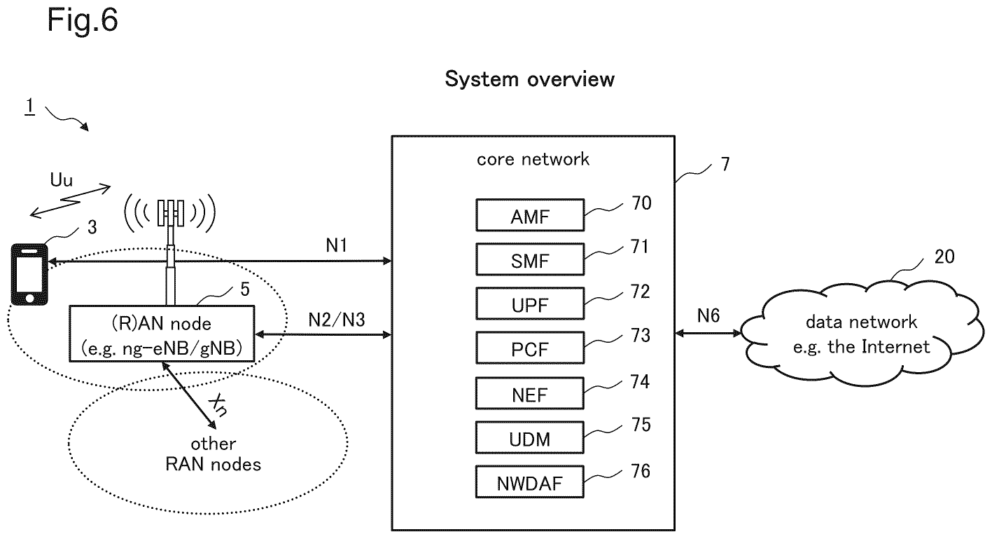

FIG. 6 schematically illustrates a telecommunication system 1 for a mobile (cellular or wireless) to which the above aspects are applicable.

The telecommunication system 1 represents a system overview in which an end to end communication is possible. For example, UE 3 (or user equipment, ‘mobile device’ 3) communicates with other UEs 3 or service servers in the data network 20 via respective (R)AN nodes 5 and a core network 7.

The (R)AN node 5 supports any radio accesses including a 5G radio access technology (RAT), an E-UTRA radio access technology, a beyond 5G RAT, a 6G RAT and non-3GPP RAT including wireless local area network (WLAN) technology as defined by the Institute of Electrical and Electronics Engineers (IEEE).

The (R)AN node 5 may split into a Radio Unit (RU), Distributed Unit (DU) and Centralized Unit (CU). In some aspects, each of the units may be connected to each other and structure the (R)AN node 5 by adopting an architecture as defined by the Open RAN (O-RAN) Alliance, where the units above are referred to as O-RU, O-DU and O-CU respectively.

The (R)AN node 5 may be split into control plane function and user plane function. Further, multiple user plane functions can be allocated to support a communication. In some aspects, user traffic may be distributed to multiple user plane functions and user traffic over each user plane functions are aggregated in both the UE 3 and the (R)AN node 5. This split architecture may be called as ‘dual connectivity’ or ‘Multi connectivity’.

The (R)AN node 5 can also support a communication using the satellite access. In some aspects, the (R)AN node 5 may support a satellite access and a terrestrial access.

In addition, the (R)AN node 5 can also be referred as an access node for a non-wireless access. The non-wireless access includes a fixed line access as defined by the Broadband Forum (BBF) and an optical access as defined by the Innovative Optical and Wireless Network (IOWN).

The core network 7 may include logical nodes (or ‘functions’) for supporting a communication in the telecommunication system 1. For example, the core network 7 may be 5G Core Network (5GC) that includes, amongst other functions, control plane functions and user plane functions. Each function in a logical nodes can be considered as a network function. The network function may be provided to another node by adapting the Service Based Architecture (SBA).

A Network Function can be deployed as distributed, redundant, stateless, and scalable that provides the services from several locations and several execution instances in each location by adapting the network virtualization technology as defined by the European Telecommunications Standards Institute, Network Functions Virtualization (ETSI NFV).

The core network 7 may support the Non-Public Network (NPN). The NPN may be a Stand-alone Non-Public Network (SNPN) or a Public Network Integrated NPN (PNI-NPN).

As is well known, a UE 3 may enter and leave the areas (i.e. radio cells) served by the (R)AN node 5 as the UE 3 is moving around in the geographical area covered by the telecommunication system 1. In order to keep track of the UE 3 and to facilitate movement between the different (R)AN nodes 5, the core network 7 comprises at least one access and mobility management function (AMF) 70. The AMF 70 is in communication with the (R)AN node 5 coupled to the core network 7. In some core networks, a mobility management entity (MME) or a mobility management node for beyond 5G or a mobility management node for 6G may be used instead of the AMF 70.

The core network 7 also includes, amongst others, a Session Management Function (SMF) 71, a User Plane Function (UPF) 72, a Policy Control Function (PCF) 73, a Network Exposure Function (NEF) 74, a Unified Data Management (UDM) 75, and a Network Data Analytics Function (NWDAF) 76. When the UE 3 is roaming to a visited Public Land Mobile Network (VPLMN), a home Public Land Mobile Network (HPLMN) of the UE 3 provides the UDM 75 and at least some of the functionalities of the SMF 71, UPF 72, and PCF 73 for the roaming-out UE 3.

The UE 3 and a respective serving (R)AN node 5 are connected via an appropriate air interface (for example the so-called “Uu” interface and/or the like). Neighboring (R)AN node 5 are connected to each other via an appropriate (R)AN node 5 to (R)AN node interface (such as the so-called “Xn” interface and/or the like). Each (R)AN node 5 is also connected to nodes in the core network 7 (such as the so-called core network nodes) via an appropriate interface (such as the so-called “N2”/“N3” interface(s) and/or the like). From the core network 7, connection to a data network 20 is also provided. The data network 20 can be an internet, a public network, an external network, a private network or an internal network of the PLMN. In case that the data network 20 is provided by a PLMN operator or Mobile Virtual Network Operator (MVNO), the IP Multimedia Subsystem (IMS) service may be provided by that data network 20. The UE 3 can be connected to the data network 20 using IPV4, IPv6, IPv4v6, Ethernet or unstructured data type.

The “Uu” interface may include a Control plane of Uu interface and User plane of Uu interface.

The User plane of Uu interface is responsible to convey user traffic between the UE 3 and a serving (R)AN node 5. The User plane of Uu interface may have a layered structure with SDAP, PDCP, RLC and MAC sublayer over the physical connection.

The Control plane of Uu interface is responsible to establish, modify and release a connection between the UE 3 and a serving (R)AN node 5. The Control plane of Uu interface may have a layered structure with RRC, PDCP, RLC and MAC sublayers over the physical connection.

For example, the following messages are communicated over the RRC layer to support AS signaling.
RRC Setup Request message: This message is sent from the UE 3 to the (R)AN node 5. In addition to the parameters that are disclosed by Aspects in this disclosure, following parameters may be included together in the RRC Setup Request message.
establishmentCause and ue-Identity. The ue-Identity may have a value of ng-5G-S-TMSI-Part1 or random Value.
RRC Setup message: This message is sent from the (R)AN node 5 to the UE 3. In addition to the parameters that are disclosed by Aspects in this disclosure, following parameters may be included together in the RRC Setup message.
masterCellGroup and radioBearerConfig
RRC Setup Complete message: This message is sent from the UE 3 to the (R)AN node 5. In addition to the parameters that are disclosed by Aspects in this disclosure, following parameters may be included together in the RRC Setup Complete message.
guami-Type, iab-NodeIndication, idleMeasAvailable, mobility State, ng-5G-S-TMSI-Part2, registeredAMF, selectedPLMN-Identity

The UE 3 and the AMF 70 are connected via an appropriate interface (for example the so-called N1 interface and/or the like). The N1 interface is responsible to provide a communication between the UE 3 and the AMF 70 to support NAS signaling. The N1 interface may be established over a 3GPP access and over a non-3GPP access. For example, the following messages are communicated over the N1 interface.
Registration Request message: This message is sent from the UE 3 to the AMF 70. In addition to the parameters that are disclosed by Aspects in this disclosure, following parameters may be included together in the Registration Request message.
5GS registration type, ngKSI, 5GS mobile identity, Non-current native NAS key set identifier, 5GMM capability, UE security capability, Requested NSSAI, Last visited registered TAI, S1 UE network capability, Uplink data status, PDU session status, MICO indication, UE status, Additional GUTI, Allowed PDU session status, UE's usage setting, Requested DRX parameters, EPS NAS message container, LADN indication, Payload container type, Payload container, Network slicing indication, 5GS update type, Mobile station classmark 2, Supported codecs, NAS message container, EPS bearer context status, Requested extended DRX parameters, T3324 value, UE radio capability ID, Requested mapped NSSAI, Additional information requested, Requested WUS assistance information, N5GC indication and Requested NB-N1 mode DRX parameters.
Registration Accept message: This message is sent from the AMF 70 to the UE 3. In addition to the parameters that are disclosed by Aspects in this disclosure, following parameters may be included together in the Registration Accept message.
5GS registration result, 5G-GUTI, Equivalent PLMNs, TAI list, Allowed NSSAI, Rejected NSSAI, Configured NSSAI, 5GS network feature support, PDU session status, PDU session reactivation result, PDU session reactivation result error cause, LADN information, MICO indication, Network slicing indication, Service area list, T3512 value, Non-3GPP de-registration timer value, T3502 value, Emergency number list, Extended emergency number list, SOR transparent container, EAP message, NSSAI inclusion mode, Operator-defined access category definitions, Negotiated DRX parameters, Non-3GPP NW policies, EPS bearer context status, Negotiated extended DRX parameters, T3447 value, T3448 value, T3324 value, UE radio capability ID, UE radio capability ID deletion indication, Pending NSSAI, Ciphering key data, CAG information list, Truncated 5G-S-TMSI configuration, Negotiated WUS assistance information, Negotiated NB-N1 mode DRX parameters and Extended rejected NSSAI.
Registration Complete message: This message is sent from the UE 3 to the AMF 70. In addition to the parameters that are disclosed by Aspects in this disclosure, following parameters may be included together in the Registration Complete message.
SOR transparent container.
Authentication Request message: This message is sent from the AMF 70 to the UE 3. In addition to the parameters that are disclosed by Aspects in this disclosure, following parameters may be included together in the Authentication Request message.
ngKSI, ABBA, Authentication parameter RAND (5G authentication challenge), Authentication parameter AUTN (5G authentication challenge) and EAP message.
Authentication Response message: This message is sent from the UE 3 to the AMF 70. In addition to the parameters that are disclosed by Aspects in this disclosure, following parameters may be populated together in the Authentication Response message.
Authentication response message identity, Authentication response parameter and EAP message.
Authentication Result message: This message is sent from the AMF 70 to the UE 3. In addition to the parameters that are disclosed by Aspects in this disclosure, following parameters may be populated together in the Authentication Result message.
ngKSI, EAP message and ABBA.
Authentication Failure message: This message is sent from the UE 3 to the AMF 70. In addition to the parameters that are disclosed by Aspects in this disclosure, following parameters may be populated together in the Authentication Failure message.
Authentication failure message identity, 5GMM cause and Authentication failure parameter.
Authentication Reject message: This message is sent from the AMF 70 to the UE 3. In addition to the parameters that are disclosed by Aspects in this disclosure, following parameters may be populated together in the Authentication Reject message.
EAP message.
Service Request message: This message is sent from the UE 3 to the AMF 70. In addition to the parameters that are disclosed by Aspects in this disclosure, following parameters may be populated together in the Service Request message.
ngKSI, Service type, 5G-S-TMSI, Uplink data status, PDU session status, Allowed PDU session status, NAS message container.
Service Accept message: This message is sent from the AMF 70 to the UE 3. In addition to the parameters that are disclosed by Aspects in this disclosure, following parameters may be populated together in the Service Accept message.
PDU session status, PDU session reactivation result, PDU session reactivation result error cause, EAP message and T3448 value.
Service Reject message: This message is sent from the AMF 70 to the UE 3. In addition to the parameters that are disclosed by Aspects in this disclosure, following parameters may be populated together in the Service Reject message.
5GMM cause, PDU session status, T3346 value, EAP message, T3448 value and CAG information list.
Configuration Update Command message: This message is sent from the AMF 70 to the UE 3. In addition to the parameters that are disclosed by Aspects in this disclosure, following parameters may be populated together in the Configuration Update Command message.
Configuration update indication, 5G-GUTI, TAI list, Allowed NSSAI, Service area list, Full name for network, Short name for network, Local time zone, Universal time and local time zone, Network daylight saving time, LADN information, MICO indication, Network slicing indication, Configured NSSAI, Rejected NSSAI, Operator-defined access category definitions, SMS indication, T3447 value, CAG information list, UE radio capability ID, UE radio capability ID deletion indication, 5GS registration result, Truncated 5G-S-TMSI configuration, Additional configuration indication and Extended rejected NSSAI.
Configuration Update Complete message: This message is sent from the UE 3 to the AMF 70. In addition to the parameters that are disclosed by Aspects in this disclosure, following parameters may be populated together in the Configuration Update Complete message.
Configuration update complete message identity.

### <User Equipment (UE)>

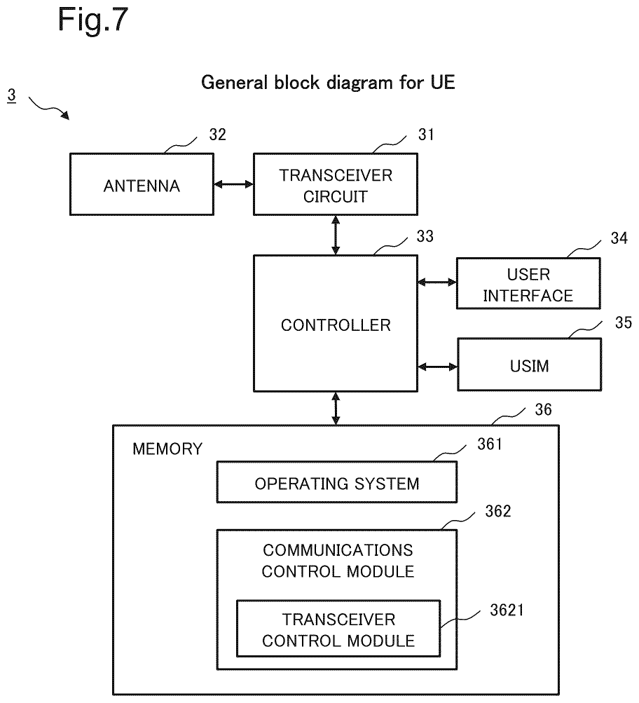

FIG. 7 is a block diagram illustrating the main components of the UE 3 (mobile device 3). As shown, the UE 3 includes a transceiver circuit 31 which is operable to transmit signals to and to receive signals from the connected node(s) via one or more antennas 32. Further, the UE 3 may include a user interface 34 for inputting information from outside or outputting information to outside. Although not necessarily shown in the Figure, the UE 3 may have all the usual functionality of a conventional mobile device and this may be provided by any one or any combination of hardware, software and firmware, as appropriate. Software may be pre-installed in the memory and/or may be downloaded via the telecommunication network or from a removable data storage device (RMD), for example. A controller 33 controls the operation of the UE 3 in accordance with software stored in a memory 36. The software includes, among other things, an operating system 361 and a communications control module 362 having at least a transceiver control module 3621. The communications control module 362 (using its transceiver control module 3621) is responsible for handling (generating/sending/receiving) signalling and uplink/downlink data packets between the UE 3 and other nodes, such as the (R)AN node 5 and the AMF 10. Such signalling may include, for example, appropriately formatted signalling messages (e.g. a registration request message and associated response messages) relating to access and mobility management procedures (for the UE 3). The controller 33 interworks with one or more Universal Subscriber Identity Module (USIM) 35. If there are multiple USIMs 35 equipped, the controller 33 may activate only one USIM 35 or may activate multiple USIMs 35 at the same time.

The UE 3 may, for example, support the Non-Public Network (NPN). The NPN may be a Stand-alone Non-Public Network (SNPN) or a Public Network Integrated NPN (PNI-NPN).

The UE 3 may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

The UE 3 may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

The UE 3 may, for example, be an item of information and communication equipment (for example information and communication equipment such as: electronic computer and related equipment; communication and related equipment; electronic components etc.).

The UE 3 may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

The UE 3 may, for example, be an electrical application system or equipment (for example an electrical application system or equipment such as: an x-ray system; a particle accelerator; radio isotope equipment; sonic equipment; electromagnetic application equipment; electronic power application equipment etc.).

The UE 3 may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

The UE 3 may, for example, be a wireless-equipped personal digital assistant or related equipment (such as a wireless card or module designed for attachment to or for insertion into another electronic device (for example a personal computer, electrical measuring machine)).

The UE 3 may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT T technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE 3 may support one or more IoT or MTC applications.

The UE 3 may be a smart phone or a wearable device (e.g. smart glasses, a smart watch, a smart ring, or a hearable device).

The UE 3 may be a car, or a connected car, or an autonomous car, or a vehicle device, or a motorcycle or V2X (Vehicle to Everything) communication module (e.g. Vehicle to Vehicle communication module, Vehicle to Infrastructure communication module, Vehicle to People communication module and Vehicle to Network communication module).

### <(R)AN Node>

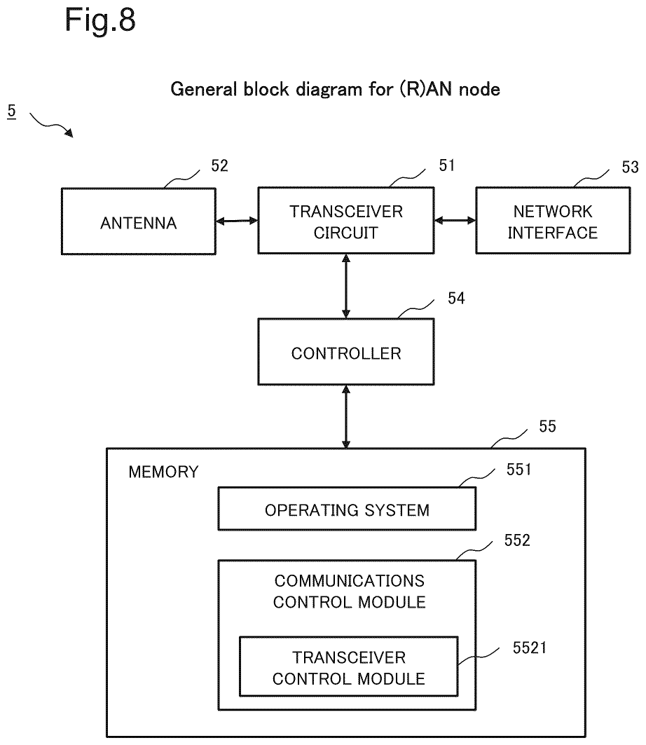

FIG. 8 is a block diagram illustrating the main components of an exemplary (R)AN node 5, for example a base station (′eNB′ in LTE, ‘gNB’ in 5G, a base station for 5G beyond, a base station for 6G). As shown, the (R)AN node 5 includes a transceiver circuit 51 which is operable to transmit signals to and to receive signals from connected UE(s) 3 via one or more antennas 52 and to transmit signals to and to receive signals from other network nodes (either directly or indirectly) via a network interface 53. A controller 54 controls the operation of the (R)AN node 5 in accordance with software stored in a memory 55. Software may be pre-installed in the memory and/or may be downloaded via the telecommunication network or from a removable data storage device (RMD), for example. The software includes, among other things, an operating system 551 and a communications control module 552 having at least a transceiver control module 5521.

The communications control module 552 (using its transceiver control sub-module) is responsible for handling (generating/sending/receiving) signalling between the (R)AN node 5 and other nodes, such as the UE 3, another (R)AN node 5, the AMF 70 and the UPF 72 (e.g. directly or indirectly). The signalling may include, for example, appropriately formatted signalling messages relating to a radio connection and a connection with the core network 7 (for a particular UE 3), and in particular, relating to connection establishment and maintenance (e.g. RRC connection establishment and other RRC messages), NG Application Protocol (NGAP) messages (i.e. messages by N2 reference point) and Xn application protocol (XnAP) messages (i.e. messages by Xn reference point), etc. Such signalling may also include, for example, broadcast information (e.g. Master Information and System information) in a sending case.

The controller 54 is also configured (by software or hardware) to handle related tasks such as, when implemented, UE mobility estimate and/or moving trajectory estimation.

The (R)AN node 5 may support the Non-Public Network (NPN). The NPN may be a Stand-alone Non-Public Network (SNPN) or a Public Network Integrated NPN (PNI-NPN).

### <System Overview of (R)AN Node 5 Based on O-RAN Architecture>

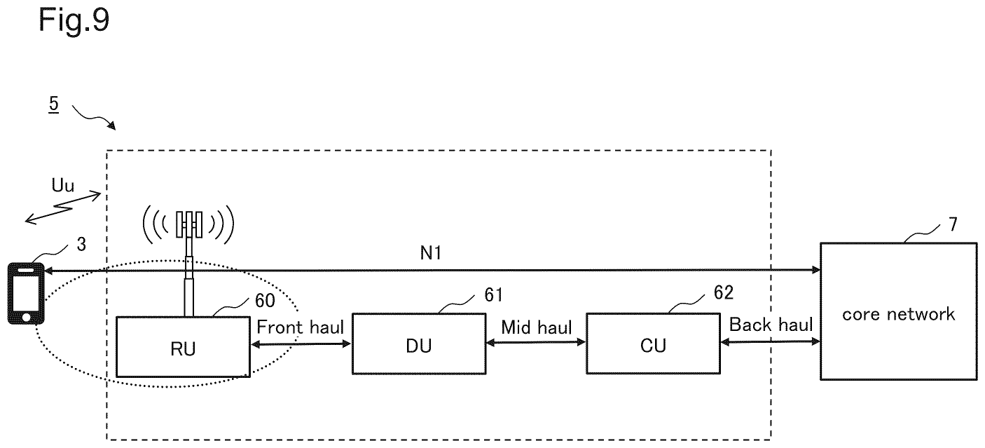

FIG. 9 schematically illustrates a (R)AN node 5 based on O-RAN architecture to which the (R)AN node 5 aspects are applicable.

The (R)AN node 5 based on O-RAN architecture represents a system overview in which the (R)AN node is split into a Radio Unit (RU) 60, Distributed Unit (DU) 61 and Centralized Unit (CU) 62. In some aspects, each unit may be combined. For example, the RU 60 can be integrated/combined with the DU 61 as an integrated/combined unit, the DU 61 can be integrated/combined with the CU 62 as another integrated/combined unit. Any functionality in the description for a unit (e.g. one of RU 60, DU 61 and CU 62) can be implemented in the integrated/combined unit above. Further, CU 62 can separate into two functional units such as CU Control plane (CP) and CU User plane (UP). The CU CP has a control plane functionality in the (R)AN node 5. The CU UP has a user plane functionality in the (R)AN node 5. Each CU CP is connected to the CU UP via an appropriate interface (such as the so-called “E1” interface and/or the like).

The UE 3 and a respective serving RU 60 are connected via an appropriate air interface (for example the so-called “Uu” interface and/or the like). Each RU 60 is connected to the DU 61 via an appropriate interface (such as the so-called “Front haul”, “Open Front haul”, “F1” interface and/or the like). Each DU 61 is connected to the CU 62 via an appropriate interface (such as the so-called “Mid haul”, “Open Mid haul”, “E2” interface and/or the like). Each CU 62 is also connected to nodes in the core network 7 (such as the so-called core network nodes) via an appropriate interface (such as the so-called “Back haul”, “Open Back haul”, “N2”/“N3” interface(s) and/or the like). In addition, a user plane part of the DU 61 can also be connected to the core network nodes 7 via an appropriate interface (such as the so-called “N3” interface(s) and/or the like).

Depending on functionality split among the RU 60, DU 61 and CU 62, each unit provides some of the functionality that is provided by the (R)AN node 5. For example, the RU 60 may provide a functionalities to communicate with a UE 3 over air interface, the DU 61 may provide functionalities to support MAC layer and RLC layer, the CU 62 may provide functionalities to support PDCP layer, SDAP layer and RRC layer.

### <Radio Unit (RU)>

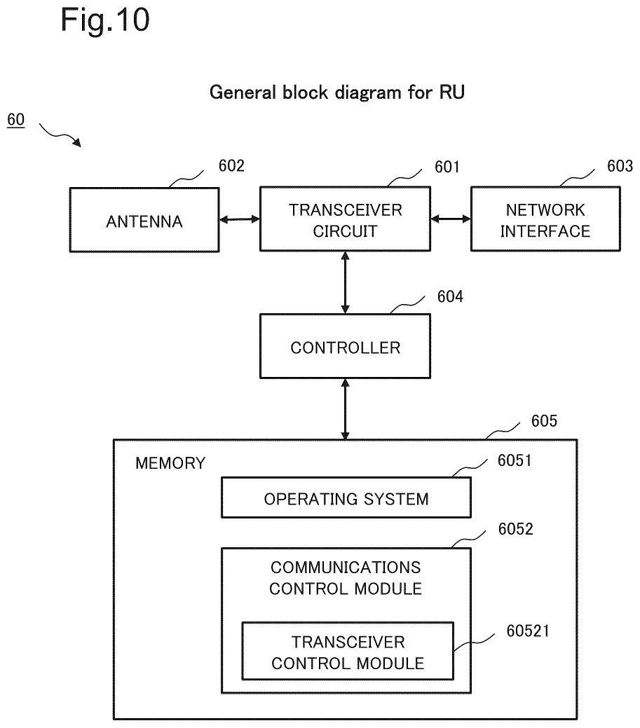

FIG. 10 is a block diagram illustrating the main components of an exemplary RU 60, for example a RU part of base station (′eNB′ in LTE, ‘gNB’ in 5G, a base station for 5G beyond, a base station for 6G). As shown, the RU 60 includes a transceiver circuit 601 which is operable to transmit signals to and to receive signals from connected UE(s) 3 via one or more antennas 602 and to transmit signals to and to receive signals from other network nodes or network unit (either directly or indirectly) via a network interface 603. A controller 604 controls the operation of the RU 60 in accordance with software stored in a memory 605. Software may be pre-installed in the memory and/or may be downloaded via the telecommunication network or from a removable data storage device (RMD), for example. The software includes, among other things, an operating system 6051 and a communications control module 6052 having at least a transceiver control module 60521.

The communications control module 6052 (using its transceiver control sub-module) is responsible for handling (generating/sending/receiving) signalling between the RU 60 and other nodes or units, such as the UE 3, another RU 60 and DU 61 (e.g. directly or indirectly). The signalling may include, for example, appropriately formatted signalling messages relating to a radio connection and a connection with the RU 60 (for a particular UE 3), and in particular, relating to MAC layer and RLC layer.

The controller 604 is also configured (by software or hardware) to handle related tasks such as, when implemented, UE mobility estimate and/or moving trajectory estimation.

The RU 60 may support the Non-Public Network (NPN). The NPN may be a Stand-alone Non-Public Network (SNPN) or a Public Network Integrated NPN (PNI-NPN).

As described above, the RU 60 can be integrated/combined with the DU 61 as an integrated/combined unit. Any functionality in the description for the RU 60 can be implemented in the integrated/combined unit above.

### <Distributed Unit (DU)>

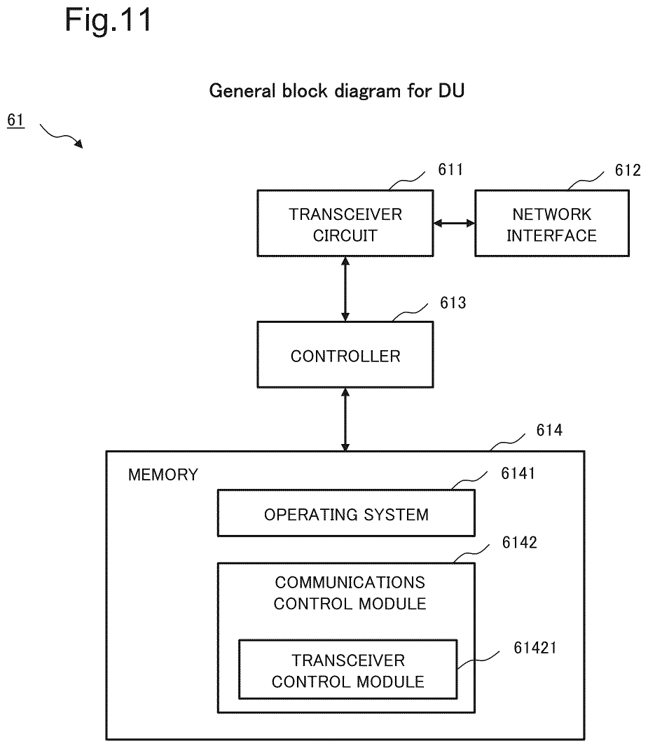

FIG. 11 is a block diagram illustrating the main components of an exemplary DU 61, for example a DU part of a base station (′eNB′ in LTE, ‘gNB’ in 5G, a base station for 5G beyond, a base station for 6G). As shown, the apparatus includes a transceiver circuit 611 which is operable to transmit signals to and to receive signals from other nodes or units (including the RU 60) via a network interface 612. A controller 613 controls the operation of the DU 61 in accordance with software stored in a memory 614. Software may be pre-installed in the memory 614 and/or may be downloaded via the telecommunication network or from a removable data storage device (RMD), for example. The software includes, among other things, an operating system 6141 and a communications control module 6142 having at least a transceiver control module 61421. The communications control module 6142 (using its transceiver control module 61421) is responsible for handling (generating/sending/receiving) signalling between the DU 61 and other nodes or units, such as the RU 60 and other nodes and units.

The DU 61 may support the Non-Public Network (NPN). The NPN may be a Stand-alone Non-Public Network (SNPN) or a Public Network Integrated NPN (PNI-NPN).

As described above, the RU 60 can be integrated/combined with the DU 61 or CU 62 as an integrated/combined unit. Any functionality in the description for DU 61 can be implemented in one of the integrated/combined unit above.

### <Centralized Unit (CU)>

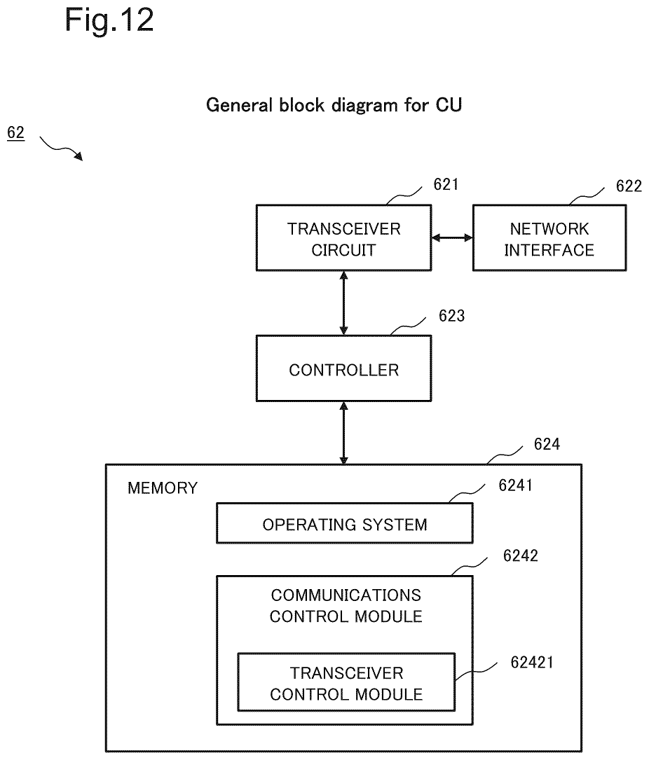

FIG. 12 is a block diagram illustrating the main components of an exemplary CU 62, for example a CU part of base station (′eNB′ in LTE, ‘gNB’ in 5G, a base station for 5G beyond, a base station for 6G). As shown, the apparatus includes a transceiver circuit 621 which is operable to transmit signals to and to receive signals from other nodes or units (including the DU 61) via a network interface 622. A controller 623 controls the operation of the CU 62 in accordance with software stored in a memory 624. Software may be pre-installed in the memory 624 and/or may be downloaded via the telecommunication network or from a removable data storage device (RMD), for example. The software includes, among other things, an operating system 6241 and a communications control module 6242 having at least a transceiver control module 62421. The communications control module 6242 (using its transceiver control module 62421) is responsible for handling (generating/sending/receiving) signalling between the CU 62 and other nodes or units, such as the DU 61 and other nodes and units.

The CU 62 may support the Non-Public Network (NPN). The NPN may be a Stand-alone Non-Public Network (SNPN) or a Public Network Integrated NPN (PNI-NPN).

As described above, the CU 62 can be integrated/combined with the DU 61 as an integrated/combined unit. Any functionality in the description for the CU 62 can be implemented in the integrated/combined unit above.

### <AMF>

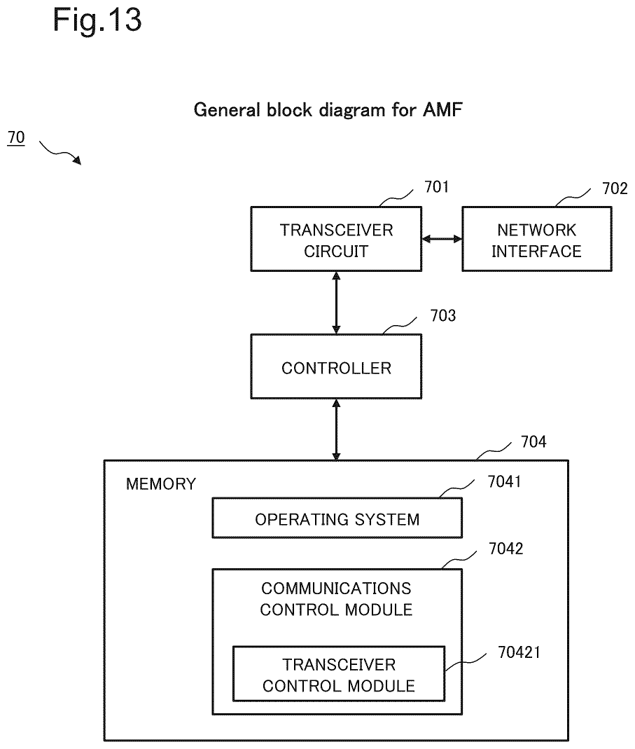

FIG. 13 is a block diagram illustrating the main components of the AMF 70. As shown, the apparatus includes a transceiver circuit 701 which is operable to transmit signals to and to receive signals from other nodes (including the UE 3) via a network interface 702. A controller 703 controls the operation of the AMF 70 in accordance with software stored in a memory 704. Software may be pre-installed in the memory 704 and/or may be downloaded via the telecommunication network or from a removable data storage device (RMD), for example. The software includes, among other things, an operating system 7041 and a communications control module 7042 having at least a transceiver control module 70421. The communications control module 7042 (using its transceiver control module 70421) is responsible for handling (generating/sending/receiving) signalling between the AMF 70 and other nodes, such as the UE 3 (e.g. via the (R)AN node 5) and other core network nodes (including core network nodes in the HPLMN of the UE 3 when the UE 3 is roaming-in). Such signalling may include, for example, appropriately formatted signalling messages (e.g. a registration request message and associated response messages) relating to access and mobility management procedures (for the UE 3).

The AMF 70 may support the Non-Public Network (NPN). The NPN may be a Stand-alone Non-Public Network (SNPN) or a Public Network Integrated NPN (PNI-NPN).

### <UDM>

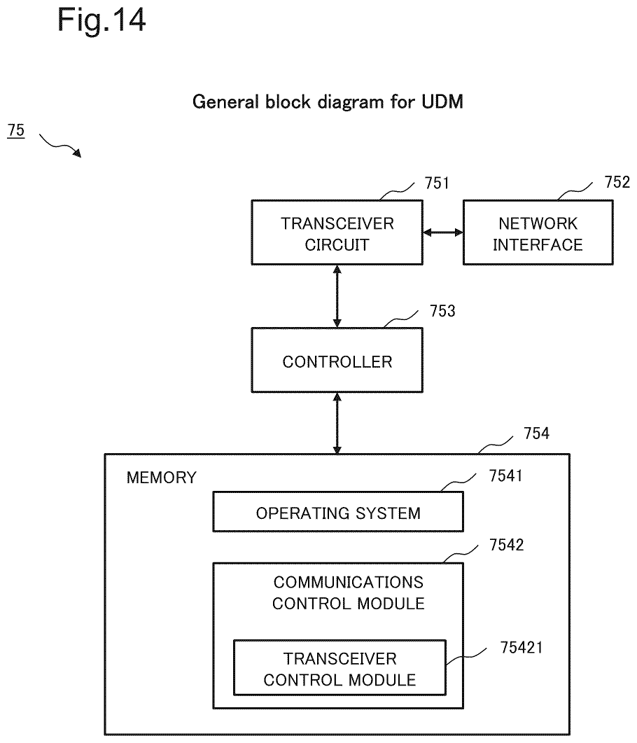

FIG. 14 is a block diagram illustrating the main components of the UDM 75. As shown, the apparatus includes a transceiver circuit 751 which is operable to transmit signals to and to receive signals from other nodes (including the AMF 70) via a network interface 752. A controller 753 controls the operation of the UDM 75 in accordance with software stored in a memory 754. Software may be pre-installed in the memory 754 and/or may be downloaded via the telecommunication network or from a removable data storage device (RMD), for example. The software includes, among other things, an operating system 7541 and a communications control module 7542 having at least a transceiver control module 75421. The communications control module 7542 (using its transceiver control module 75421) is responsible for handling (generating/sending/receiving) signalling between the UDM 75 and other nodes, such as the AMF 70 and other core network nodes (including core network nodes in the VPLMN of the UE 3 when the UE 3 is roaming-out). Such signalling may include, for example, appropriately formatted signalling messages (e.g. a HTTP restful methods based on the service based interfaces) relating to mobility management procedures (for the UE 3).

The UDM 75 may support the Non-Public Network (NPN). The NPN may be a Stand-alone Non-Public Network (SNPN) or a Public Network Integrated NPN (PNI-NPN).

### Modifications and Alternatives

Detailed aspects have been described above. As those skilled in the art will appreciate, a number of modifications and alternatives can be made to the above aspects whilst still benefiting from the disclosures embodied therein. By way of illustration only a number of these alternatives and modifications will now be described.

In the above description, the UE 3 and the network apparatus are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like. In the above aspects, a number of software modules were described. As those skilled in the art will appreciate, the software modules may be provided in compiled or un-compiled form and may be supplied to the UE 3 and the network apparatus as a signal over a computer network, or on a recording medium. Further, the functionality performed by part or all of this software may be performed using one or more dedicated hardware circuits. However, the use of software modules is preferred as it facilitates the updating of the UE 3 and the network apparatus in order to update their functionalities.

In the above aspects, a 3GPP radio communications (radio access) technology is used. However, any other radio communications technology (e.g. WLAN, Wi-Fi, WiMAX, Bluetooth, etc.) and other fix line communications technology (e.g. BBF Access, Cable Access, optical access, etc.) may also be used in accordance with the above aspects.

Items of user equipment might include, for example, communication devices such as mobile telephones, smartphones, user equipment, personal digital assistants, laptop/tablet computers, web browsers, e-book readers and/or the like. Such mobile (or even generally stationary) devices are typically operated by a user, although it is also possible to connect so-called ‘Internet of Things’ (IoT) devices and similar machine-type communication (MTC) devices to the network. For simplicity, the present application refers to mobile devices (or UEs) in the description but it will be appreciated that the technology described can be implemented on any communication devices (mobile and/or generally stationary) that can connect to a communications network for sending/receiving data, regardless of whether such communication devices are controlled by human input or software instructions stored in memory.

Various other modifications will be apparent to those skilled in the art and will not be described in further detail here.

The whole or part of the example embodiments disclosed above can be described as, but not limited to, the following.

### <3.2 Abbreviations>

For the purposes of the present document, the abbreviations given in TR 21.905 [1] and the following apply. An abbreviation defined in the present document takes precedence over the definition of the same abbreviation, if any, in TR 21.905 [1].

| | |
|---|---|
| 5GC | 5G Core Network |
| 5G-VN | 5G Local Area Network |
| 5GS | 5G System |
| 5G-AN | 5G Access Network |
| 5G-AN PDB | 5G Access Network Packet Delay Budget |
| 5G-EIR | 5G-Equipment Identity Register |
| 5G-GUTI | 5G Globally Unique Temporary Identifier |
| 5G-BRG | 5G Broadband Residential Gateway |
| 5G-CRG | 5G Cable Residential Gateway |
| 5G GM | 5G Grand Master |
| 5G-RG | 5G Residential Gateway |
| 5G-S-TMSI | 5G S-Temporary Mobile Subscription Identifier |
| 5G VN | 5G Virtual Network |
| 5QI | 5G QoS Identifier |
| ADRF | Analytics Data Repository Function |
| AF | Application Function |
| AKMA | Authentication and Key Management for Applications |
| AnLF | Analytics Logical Function |
| AMF | Access and Mobility Management Function |
| AS | Access Stratum |
| ATSSS | Access Traffic Steering, Switching, Splitting |
| ATSSS-LL | ATSSS Low-Layer |
| AUSF | Authentication Server Function |
| BMCA | Best Master Clock Algorithm |
| BSF | Binding Support Function |
| CAG | Closed Access Group |
| CAPIF | Common API Framework for 3GPP northbound APIs |
| CH | Credentials Holder |
| CHF | Charging Function |
| CN PDB | Core Network Packet Delay Budget |
| CP | Control Plane |
| DAPS | Dual Active Protocol Stacks |
| DCCF | Data Collection Coordination Function |
| DL | Downlink |
| DN | Data Network |
| DNAI | DN Access Identifier |
| DNN | Data Network Name |
| DRX | Discontinuous Reception |
| DS-TT | Device-side TSN translator |
| ePDG | evolved Packet Data Gateway |
| EBI | EPS Bearer Identity |
| EUI | Extended Unique Identifier |
| FAR | Forwarding Action Rule |
| FN-BRG | Fixed Network Broadband RG |
| FN-CRG | Fixed Network Cable RG |
| FN-RG | Fixed Network RG |
| FQDN | Fully Qualified Domain Name |
| GFBR | Guaranteed Flow Bit Rate |
| GIN | Group ID for Network Selection |
| GMLC | Gateway Mobile Location Centre |
| GPSI | Generic Public Subscription Identifier |
| GUAMI | Globally Unique AMF Identifier |
| HMTC | High-Performance Machine-Type Communications |
| HR | Home Routed (roaming) |
| IAB | Integrated access and backhaul |
| IMEI/TAC | IMEI Type Allocation Code |
| IPUPS | Inter PLMN UP Security |
| I-SMF | Intermediate SMF |
| I-UPF | Intermediate UPF |
| LADN | Local Area Data Network |
| LBO | Local Break Out (roaming) |
| LMF | Location Management Function |
| LoA | Level of Automation |
| LPP | LTE Positioning Protocol |
| LRF | Location Retrieval Function |
| MFAF | Messaging Framework Adaptor Function |
| MCX | Mission Critical Service |
| MDBV | Maximum Data Burst Volume |
| MFBR | Maximum Flow Bit Rate |
| MICO | Mobile Initiated Connection Only |
| ML | Machine Learning |
| MPS | Multimedia Priority Service |
| MPTCP | Multi-Path TCP Protocol |
| MTLF | Model Training Logical Function |
| N3IWF | Non-3GPP InterWorking Function |
| N5CW | Non-5G-Capable over WLAN |
| NAI | Network Access Identifier |
| NEF | Network Exposure Function |
| NF | Network Function |
| NGAP | Next Generation Application Protocol |
| NID | Network identifier |
| NPN | Non-Public Network |
| NR | New Radio |
| NRF | Network Repository Function |
| NSAC | Network Slice Admission Control |
| NSACF | Network Slice Admission Control Function |
| NSI ID | Network Slice Instance Identifier |
| NSSAA | Network Slice-Specific Authentication and Authorization |
| NSSAAF | Network Slice-Specific Authentication and Authorization |
| | Function |
| NSSAI | Network Slice Selection Assistance Information |
| NSSF | Network Slice Selection Function |
| NSSP | Network Slice Selection Policy |
| NSSRG | Network Slice Simultaneous Registration Group |
| NW-TT | Network-side TSN translator |
| NWDAF | Network Data Analytics Function |
| PCF | Policy Control Function |
| PDB | Packet Delay Budget |
| PDR | Packet Detection Rule |
| PDU | Protocol Data Unit |
| PEI | Permanent Equipment Identifier |
| PER | Packet Error Rate |
| PFD | Packet Flow Description |
| PNI-NPN | Public Network Integrated Non-Public Network |
| PPD | Paging Policy Differentiation |
| PPF | Paging Proceed Flag |
| PPI | Paging Policy Indicator |
| PSA | PDU Session Anchor |
| PTP | Precision Time Protocol |
| QFI | QoS Flow Identifier |
| QoE | Quality of Experience |
| RACS | Radio Capabilities Signalling optimisation |
| (R)AN | (Radio) Access Network |
| RG | Residential Gateway |
| RIM | Remote Interference Management |
| RQA | Reflective QoS Attribute |
| RQI | Reflective QoS Indication |
| RSN | Redundancy Sequence Number |
| SA NR | Standalone New Radio |
| SBA | Service Based Architecture |
| SBI | Service Based Interface |
| SCP | Service Communication Proxy |
| SD | Slice Differentiator |
| SEAF | Security Anchor Functionality |
| SEPP | Security Edge Protection Proxy |
| SMF | Session Management Function |
| SMSF | Short Message Service Function |
| SN | Sequence Number |
| SNPN | Stand-alone Non-Public Network |
| S-NSSAI | Single Network Slice Selection Assistance |
| | Information |
| SSC | Session and Service Continuity |
| SSCMSP | Session and Service Continuity Mode Selection |
| | Policy |
| SST | Slice/Service Type |
| SUCI | Subscription Concealed Identifier |
| SUPI | Subscription Permanent Identifier |
| SV | Software Version |
| TNAN | Trusted Non-3GPP Access Network |
| TNAP | Trusted Non-3GPP Access Point |
| TNGF | Trusted Non-3GPP Gateway Function |
| TNL | Transport Network Layer |
| TNLA | Transport Network Layer Association |
| TSC | Time Sensitive Communication |
| TSCAI | TSC Assistance Information |
| TSN | Time Sensitive Networking |
| TSN GM | TSN Grand Master |
| TSP | Traffic Steering Policy |
| TT | TSN Translator |
| TWIF | Trusted WLAN Interworking Function |
| UCMF | UE radio Capability Management Function |
| UDM | Unified Data Management |
| UDR | Unified Data Repository |
| UDSF | Unstructured Data Storage Function |
| UL | Uplink |
| UL CL | Uplink Classifier |
| UPF | User Plane Function |
| URLLC | Ultra Reliable Low Latency Communication |
| URRP-AMF | UE Reachability Request Parameter for AMF |
| URSP | UE Route Selection Policy |
| VID | VLAN Identifier |
| VLAN | Virtual Local Area Network |
| W-5GAN | Wireline 5G Access Network |
| W-5GBAN | Wireline BBF Access Network |
| W-5GCAN | Wireline 5G Cable Access Network |
| W-AGF | Wireline Access Gateway Function |

### <5.15.2.1 General >

An S-NSSAI identifies a Network Slice.

An S-NSSAI is comprised of:
A Slice/Service type (SST), which refers to the expected Network Slice behaviour in terms of features and services;
A Slice Differentiator (SD), which is optional information that complements the Slice/Service type(s) to differentiate amongst multiple Network Slices of the same Slice/Service type.

An S-NSSAI can have standard values (i.e. such S-NSSAI is only comprised of an SST with a standardised SST value, see clause 5.15.2.2, and no SD) or non-standard values (i.e. such S-NSSAI is comprised of either both an SST and an SD or only an SST without a standardised SST value and no SD). An S-NSSAI with a non-standard value identifies a single Network Slice within the PLMN with which it is associated.

An S-NSSAI with a non-standard value shall not be used by the UE in access stratum procedures in any PLMN other than the one to which the S-NSSAI is associated.

The S-NSSAIs in the NSSP of the URSP rules (see TS 23.503 clause 6.6.2) and in the Subscribed S-NSSAIs (see clause 5.15.3) contain only HPLMN S-NSSAI values.

The S-NSSAIs in the Configured NSSAI, the Allowed NSSAI (see clause 5.15.4.1), the Requested NSSAI (see clause 5.15.5.2.1), the Rejected S-NSSAIs contain only values from the Serving PLMN. The Serving PLMN can be the HPLMN or a VPLMN.

The S-NSSAI(s) in the PDU Session Establishment contain one Serving PLMN S-NSSAI value and in addition may contain a corresponding HPLMN S-NSSAI value to which this first value is mapped (see clause 5.15.5.3).

The optional mapping of Serving PLMN S-NSSAIs to HPLMN S-NSSAIs contains Serving PLMN S-NSSAI values and corresponding mapped HPLMN S-NSSAI values.

The NSSAI is a collection of S-NSSAIs. An NSSAI may be a Configured NSSAI, a Requested NSSAI or an Allowed NSSAI. There can be at most eight S-NSSAIs in Allowed and Requested NSSAIs sent in signalling messages between the UE and the Network. The Requested NSSAI signalled by the UE to the network allows the network to select the Serving AMF, Network Slice(s) and Network Slice instance(s) for this UE, as specified in clause 5.15.5.

Based on the operator's operational or deployment needs, a Network Slice instance can be associated with one or more S-NSSAIs, and an S-NSSAI can be associated with one or more Network Slice instances. Multiple Network Slice instances associated with the same S-NSSAI may be deployed in the same or in different Tracking Areas. When multiple Network Slice instances associated with the same S-NSSAI are deployed in the same Tracking Areas, the AMF instance serving the UE may logically belong to (i.e. be common to) more than one Network Slice instance associated with this S-NSSAI.

In a PLMN, when an S-NSSAI is associated with more than one Network Slice instance, one of these Network Slice instances, as a result of the Network Slice instance selection procedure defined in clause 5.15.5, serves a UE that is allowed to use this S-NSSAI. For any S-NSSAI, the network may at any one time serve the UE with only one Network Slice instance associated with this S-NSSAI until cases occur where e.g. this Network Slice instance is no longer valid in a given Registration Area, or a change in UE's Allowed NSSAI occurs, etc. In such cases, procedures mentioned in clause 5.15.5.2.2 or clause 5.15.5.2.3 apply.

Based on the Requested NSSAI (if any) and the Subscription Information, the 5GC is responsible for selection of a Network Slice instance(s) to serve a UE including the 5GC Control Plane and User Plane Network Functions corresponding to this Network Slice instance(s). The Subscription Information may contain restrictions to the simultaneous registration of network slices. This is provided to the serving AMF as part of the UE subscription, in the form of Network Slice Simultaneous Registration Group (NSSRG) information (see clause 5.15.x).

The (R)AN may use Requested NSSAI in access stratum signalling to handle the UE Control Plane connection before the 5GC informs the (R)AN of the Allowed NSSAI. The Requested NSSAI is used by the RAN for AMF selection, as described in clause 6.3.5. The UE shall not include the Requested NSSAI in the RRC Resume when the UE asks to resume the RRC connection and is CM-CONNECTED with RRC Inactive state.

When a UE is successfully registered over an Access Type, the CN informs the (R)AN by providing the Allowed NSSAI for the corresponding Access Type.

NOTE: The details of how the RAN uses NSSAI information are described in TS 38.300 [27].

### <5.15.3 Subscription Aspects>

The Subscription Information shall contain one or more S-NSSAIs i.e. Subscribed S-NSSAIs. Based on operator's policy, one or more Subscribed S-NSSAIs can be marked as a default S-NSSAI. If an S-NSSAI is marked as default, then the network is expected to serve the UE with a related applicable Network Slice instance when the UE does not send any permitted S-NSSAI to the network in a Registration Request message as part of the Requested NSSAI.

The Subscription Information for each S-NSSAI may contain:
a Subscribed DNN list and one default DNN; and
the indication whether the S-NSSAI is marked as default Subscribed S-NSSAI; and
the indication whether the S-NSSAI is subject to Network Slice-Specific Authentication and Authorization; and
Network Slice Simultaneous Usage Group (NSSRG) information (see clause 5.15.x)

The network verifies the Requested NSSAI the UE provides in the Registration Request against the Subscription Information. For the S-NSSAIs subject to Network Slice-Specific Authentication and Authorization the clause 5.15.10 applies.
NOTE 1: It is recommended that at least one of the Subscribed S-NSSAIs marked as default S-NSSAI is not subject to Network Slice-specific Authentication and Authorization, in order to ensure access to services even when Network Slice-specific Authentication and Authorization fails.
NOTE 2: It is recommended to minimize the number of Subscribed S-NSSAIs in subscriptions for NB-IoT capable UEs to minimize overhead for signalling a large number of S-NSSAIs in Requested NSSAI in RRC and NAS via NB-IoT.

In roaming case, the UDM shall provide to the VPLMN only the S-NSSAIs from the Subscribed S-NSSAIs the HPLMN allows for the UE in the VPLMN. If the UE is subject to restrictions of simultaneous registration of network slices (i.e. if the Subscription Information for the S-NSSAIs contains NSSRG information), the UDM provides to the VPLMN subscribed S-NSSAIs and, if applicable, NSSRG information, as described in clause 5.15.x.
NOTE 3: Network slice instances supporting an S-NSSAI subject to Network Slice-Specific Authentication and Authorization need to be deployed with AMFs supporting Network Slice-Specific Authentication and Authorization, otherwise S-NSSAIs requiring Network Slice-Specific Authentication and Authorization would be incorrectly allowed without execution of Network Slice-Specific Authentication and Authorization.

When the UDM updates the Subscribed S-NSSAI(s) to the serving AMF, based on configuration in this AMF, the AMF itself or the NSSF determines the mapping of the Configured NSSAI for the Serving PLMN and/or Allowed NSSAI to the Subscribed S-NSSAI(s). The serving AMF then updates the UE with the above information as described in clause 5.15.4.

### <5.15.4.1.1 UE Network Slice Configuration>

The Network Slice configuration information contains one or more Configured NSSAI(s). A Configured NSSAI may either be configured by a Serving PLMN and apply to the Serving PLMN, or may be a Default Configured NSSAI configured by the HPLMN and that applies to any PLMNs for which no specific Configured NSSAI has been provided to the UE. There is at most one Configured NSSAI per PLMN.
NOTE 1: The value(s) used in the Default Configured NSSAI are expected to be commonly decided by all roaming partners, e.g. by the use of values standardized by 3GPP or other bodies.

The Default Configured NSSAI, if it is configured in the UE, is used by the UE in a Serving PLMN only if the UE has no Configured NSSAI for the Serving PLMN.

The Configured NSSAI of a PLMN may include S-NSSAIs that have standard values or PLMN-specific values.

The Configured NSSAI for the Serving PLMN includes the S-NSSAI values which can be used in the Serving PLMN and may be associated with mapping of each S-NSSAI of the Configured NSSAI to one or more corresponding HPLMN S-NSSAI values.

A UE subscription may contain Network Slice Simultaneous Registration Group (NSSRG) information. If so, the UE configuration is performed as described in clause 5.15.x.2.

The UE may be pre-configured with the Default Configured NSSAI. The UE may be provisioned/updated with the Default Configured NSSAI, determined by the UDM in the HPLMN, using the UE Parameters Update via UDM Control Plane procedure defined in clause 4.20 of TS 23.502 [3]. Each S-NSSAI in the Default Configured NSSAI may have a corresponding S-NSSAI as part of the Subscribed S-NSSAI(s). Consequently, if the Subscribed S-NSSAI(s) which are also present in the Default Configured NSSAI are updated the UDM should update the Default Configured NSSAI in the UE.

In the HPLMN, the S-NSSAIs in the Configured NSSAI provided as described in clause 5.15.4.2, at the time when they are provided to the UE, shall match the Subscribed S-NSSAIs for the UE. When the Subscribed S-NSSAI(s) are updated (i.e. some existing S-NSSAIs are removed and/or some new S-NSSAIs are added) and one or more are applicable to the Serving PLMN the UE is registered in, as described in clause 5.15.3, or when the associated mapping is updated the AMF shall update the UE with the Configured NSSAI for the Serving PLMN and/or Allowed NSSAI and/or the associated mapping to HPLMN S-NSSAIs (see clause 5.15.4.2). When there is the need to update the Allowed NSSAI, the AMF shall provide the UE with the new Allowed NSSAI and the associated mapping to HPLMN S-NSSAIs, unless the AMF cannot determine the new Allowed NSSAI (e.g. all S-NSSAIs in the old Allowed NSSAI have been removed from the Subscribed S-NSSAIs), in which case the AMF shall not send any Allowed NSSAI to the UE but indicate to the UE to perform a Registration procedure. If the UE is in a CM-IDLE state, the AMF may trigger Network Triggered Service Request or wait until the UE is in a CM-CONNECTED state as described in clause 4.2.4.2, TS 23.502 [3].

When providing a Requested NSSAI to the network upon registration, the UE in a given PLMN only includes and uses S-NSSAIs applying to this PLMN. The mapping of S-NSSAIs of the Requested NSSAI to HPLMN S-NSSAIs may also be provided (see clause 5.15.4.1.2 for when this is needed). The S-NSSAIs in the Requested NSSAI are part of the Configured and/or Allowed NSSAIs applicable for this PLMN, when they are available. If the UE has received NSSRG information together with the Configured NSSAI, it only includes in the Requested NSSAI S-NSSAIs that all share a common NSSRG. If no Configured NSSAI and Allowed NSSAI for the PLMN are available, the S-NSSAIs in the Requested NSSAI correspond to the Default Configured NSSAI, if configured in the UE. Upon successful completion of a UE's Registration procedure over an Access Type, the UE obtains from the AMF an Allowed NSSAI for this Access Type, which includes one or more S-NSSAIs and, if needed (see clause 5.15.4.1.2 for when this is needed), their mapping to the HPLMN S-NSSAIs. These S-NSSAIs are valid for the current Registration Area and Access Type provided by the AMF the UE has registered with and can be used simultaneously by the UE (up to the maximum number of simultaneous Network Slice instances or PDU Sessions).

The UE might also obtain one or more rejected S-NSSAIs with cause and validity of rejection from the AMF. An S-NSSAI may be rejected:
for the entire PLMN; or
for the current Registration Area.

While it remains RM-REGISTERED in the PLMN and regardless of the Access Type, the UE shall not re-attempt to register to an S-NSSAI rejected for the entire PLMN until this rejected S-NSSAI is deleted as specified below.

While it remains RM-REGISTERED in the PLMN, the UE shall not re-attempt to register to an S-NSSAI rejected in the current Registration Area until it moves out of the current Registration Area.
NOTE 2: The details and more cases of S-NSSAI rejection are described in TS 24.501 [47].

S-NSSAIs that the UE provides in the Requested NSSAI which are neither in the Allowed NSSAI nor provided as a rejected S-NSSAI, shall, by the UE, not be regarded as rejected, i.e. the UE may request to register these S-NSSAIs again next time the UE sends a Requested NSSAI.

The UE stores (S-)NSSAIs as follows:
When provisioned with a Configured NSSAI for a PLMN and/or a mapping of Configured NSSAI to HPLMN S-NSSAIs and possibly NSSRG information for each S-NSSAI in the Configured NSSAI (if applicable and supported by the UE), or when requested to remove the configuration due to network slicing subscription change, the UE shall:
replace any stored (old) Configured NSSAI for this PLMN with the new Configured NSSAI for this PLMN (if applicable); and
delete any stored associated mapping of this old Configured NSSAI for this PLMN to HPLMN S-NSSAIs and, if present and applicable, store the mapping of Configured NSSAI to HPLMN S-NSSAIs; and
delete any stored associated NSSRG information for each S-NSSAI of the Configured NSSAI and, if present, store the associated NSSRG information for each S-NSSAI of the Configured NSSAI; and
delete any stored rejected S-NSSAI for this PLMN;
keep the received Configured NSSAI for a PLMN (if applicable) and associated mapping to HPLMN S-NSSAIs (if applicable) and associated NSSRG information for each S-NSSAI of the Configured NSSAI (if applicable and supported by the UE) stored in the UE, even when registering in another PLMN, until a new Configured NSSAI for this PLMN and/or associated mapping are provisioned in the UE, or until the network slicing subscription changes, as described in clause 5.15.4.2. The number of Configured NSSAIs and associated mapping to be kept stored in the UE for PLMNs other than the HPLMN is up to UE implementation. A UE shall at least be capable of storing a Configured NSSAI for the serving PLMN including any necessary mapping of the Configured NSSAI for the Serving PLMN to HPLMN S-NSSAIs and the Default Configured NSSAI.
The Allowed NSSAI received in a Registration Accept message or a UE Configuration Update Command applies to a PLMN when at least a TAI of this PLMN is included in the RA/TAI list included in this Registration Accept message or UE Configuration Update Command. If the UE Configuration Update Command contains an Allowed NSSAI but not a TAI List, then the last received RA/TAI list applies for the decision on which PLMN(s) the Allowed NSSAI is applicable. If received, the Allowed NSSAI for a PLMN and Access Type and any associated mapping of this Allowed NSSAI to HPLMN S-NSSAIs shall be stored in the UE. The UE should store this Allowed NSSAI and any associated mapping of this Allowed NSSAI to HPLMN S-NSSAIs also when the UE is turned off, or until the network slicing subscription changes, as described in clause 5.15.4.2:
NOTE 3: Whether the UE stores the Allowed NSSAI and any associated mapping of the Allowed NSSAI to HPLMN S-NSSAIS also when the UE is turned off is left to UE implementation.
When a new Allowed NSSAI for a PLMN and any associated mapping of the Allowed NSSAI to HPLMN S-NSSAIs are received over an Access Type, the UE shall:
   replace any stored (old) Allowed NSSAI and any associated mapping for these PLMN and Access Type with this new Allowed NSSAI; and
   delete any stored associated mapping of this old Allowed NSSAI for this PLMN to HPLMN S-NSSAIs and, if present, store the associated mapping of this new Allowed NSSAI to HPLMN S-NSSAIs;
If received, an S-NSSAI rejected for the entire PLMN shall be stored in the UE while RM-REGISTERED in this PLMN regardless of the Access Type or until it is deleted.
If received, an S-NSSAI rejected for the current Registration Area shall be stored in the UE while RM-REGISTERED until the UE moves out of the current Registration Area or until the S-NSSAI is deleted.
NOTE 4: The storage aspects of rejected S-NSSAIs are described in TS 24.501 [47].
If received, the Pending NSSAI shall be stored in the UE as described in TS 24.501 [47].

### <5.15.4.2 Update of UE Network Slice Configuration>

At any time, the AMF may provide the UE with a new Configured NSSAI for the Serving PLMN, associated with mapping of the Configured NSSAI to HPLMN S-NSSAIs as specified in clause 5.15.4.1. The Configured NSSAI for the Serving PLMN and the mapping information is either determined in the AMF (if based on configuration, the AMF is allowed to determine the Network Slice configuration for the whole PLMN) or by the NSSF. The AMF provides an updated Configured NSSAI as specified in TS 23.502 [3], clause 4.2.4 UE Configuration Update procedure.

The AMF shall provide the UE with NSSRG information alongside the Configured NSSAI if NSSRG information is included in the subscription information received from the UDM and if the UE has indicated support for the feature as part of the registration request, see clause 5.15.x.

If the HPLMN performs the configuration update of a UE registered in the HPLMN (e.g. due to a change in the Subscribed S-NSSAI(s) or due to a change of NSSRG information), this results in updates to the Configured NSSAI for the HPLMN and, if applicable, NSSRG information for each S-NSSAI of the Configured NSSAI. Updates to the Allowed NSSAI and/or, if present, to the associated mapping of the Allowed NSSAI to HPLMN S-NSSAIs are also possible if the configuration update affects S-NSSAI(s) in the current Allowed NSSAI.

If the VPLMN performs the configuration update of a UE registered in the VPLMN (e.g. due to a change in the Subscribed S-NSSAI(s), the associated mapping is updated, or due to a change of NSSRG information), this results in updates to the Configured NSSAI for the Serving PLMN and/or to the associated mapping of the Configured NSSAI for the Serving PLMN to HPLMN S-NSSAIS and, if applicable, NSSRG information for each S-NSSAI of the Configured NSSAI. Updates to the Allowed NSSAI and/or to the associated mapping of the Allowed NSSAI to HPLMN S-NSSAIs are also possible if the configuration update affects S-NSSAI(s) in the current Allowed NSSAI.

A UE for which the Configured NSSAI for the Serving PLMN has been updated as described in clause 5.15.4.1 and has been requested to perform a Registration procedure, shall initiate a Registration procedure to receive a new valid Allowed NSSAI (see clause 5.15.5.2.2).

When the subscribed S-NSSAIs change, a UDR flag is set in the HPLMN to make sure the current PLMN (or, if the UE was not reachable, the next serving PLMN) is informed by the UDM that the subscription data for network slicing has changed. The AMF, when it receives the indication from the UDM subscription has changed, indicates the UE that subscription has changed and uses any updated subscription information from the UDM to update the UE. Once the AMF updates the UE and obtains an acknowledgment from the UE, the AMF informs the UDM that the configuration update was successful and the UDM clears the flag in the UDR. If the UE is in a CM-IDLE state, the AMF may trigger Network Triggered Service Request or wait until the UE is in a CM-CONNECTED state as described in clause 4.2.4.2, TS 23.502 [3].

If the UE receives indication from the AMF that Network Slicing subscription has changed, the UE locally deletes the network slicing information it has for all PLMNs, except the Default Configured NSSAI (if present). It also updates the current PLMN network slicing configuration information with any received values from the AMF.

The update of URSP rules (which include the NSSP), if necessary at any time, is described in TS 23.503 [45].

### <5.15.5.2.1 Registration to a Set of Network Slices>

When a UE registers over an Access Type with a PLMN, if the UE has either or both of:
a Configured NSSAI for this PLMN;
an Allowed NSSAI for this PLMN and Access Type;
   the UE shall provide to the network, in AS layer under the conditions described in clause 5.15.9 and in NAS layer, a Requested NSSAI containing the S-NSSAI(s) corresponding to the Network Slice(s) to which the UE wishes to register, unless they are stored in the UE in the Pending NSSAI.

The Requested NSSAI shall be one of:
the Default Configured NSSAI, i.e. if the UE has no Configured NSSAI nor an Allowed NSSAI for the serving PLMN;
the Configured-NSSAI, or a subset thereof as described below, e.g. if the UE has no Allowed NSSAI for the Access Type for the serving PLMN;
the Allowed-NSSAI for the Access Type over which the Requested NSSAI is sent, or a subset thereof; or
the Allowed-NSSAI for the Access Type over which the Requested NSSAI is sent, or a subset thereof, plus one or more S-NSSAIs from the Configured-NSSAI not yet in the Allowed NSSAI for the Access Type as described below.
NOTE 1: If the UE wishes to register only a subset of the S-NSSAIs from the Configured NSSAI or the Allowed NSSAI, to be able to register with some Network Slices e.g. to establish PDU Sessions for some application(s), and the UE uses the URSP rules (which includes the NSSP) or the UE Local Configuration as defined in clause 6.1.2.2.1 of TS 23.503 [45], then the UE uses applicable the URSP rules or the UE Local Configuration to ensure that the S-NSSAIs included in the Requested NSSAI are not in conflict with the URSP rules or with the UE Local Configuration.

The subset of S-NSSAIs in the Configured-NSSAI provided in the Requested NSSAI consists of one or more S-NSSAI(s) in the Configured NSSAI applicable to this PLMN, if one is present, and for which no corresponding S-NSSAI is already present in the Allowed NSSAI for the access type for this PLMN. The UE shall not include in the Requested NSSAI any S-NSSAI that is currently rejected by the network (i.e. rejected in the current registration area or rejected in the PLMN). For the registration to a PLMN for which neither a Configured NSSAI applicable to this PLMN or an Allowed NSSAI are present, the S-NSSAIs provided in the Requested NSSAI correspond to the S-NSSAI(s) in the Default Configured NSSAI unless the UE has HPLMN S-NSSAI for established PDU Session(s) in which case the HPLMN S-NSSAI(s) shall be provided in the mapping of Requested NSSAI in the NAS Registration Request message, with no corresponding VPLMN S-NSSAI in the Requested NSSAI. If the UE has been provided with NSSRG information together with the Configured NSSAI, the UE only includes in the Requested NSSAI S-NSSAIs that share a common NSSRG, see clause 5.15.x.2.

When a UE registers over an Access Type with a PLMN, the UE shall also indicate in the Registration Request message when the Requested NSSAI is based on the Default Configured NSSAI.

The UE shall include the Requested NSSAI in the RRC Connection Establishment and in the establishment of the connection to the N3IWF/TNGF (as applicable) and in the NAS Registration procedure messages subject to conditions set out in clause 5.15.9. However, the UE shall not indicate any NSSAI in RRC Connection Establishment or Initial NAS message unless it has either a Configured NSSAI for the corresponding PLMN, an Allowed NSSAI for the corresponding PLMN and Access Type, or the Default Configured NSSAI. If the UE has HPLMN S-NSSAI(s) for established PDU Session(s), the HPLMN S-NSSAI(s) shall be provided in the mapping of Requested NSSAI in the NAS Registration Request message, independent of whether the UE has the corresponding VPLMN S-NSSAI. The (R)AN shall route the NAS signalling between this UE and an AMF selected using the Requested NSSAI obtained during RRC Connection Establishment or connection to N3IWF/TNGF respectively. If the (R)AN is unable to select an AMF based on the Requested NSSAI, it routes the NAS signalling to an AMF from a set of default AMFs. In the NAS signalling, if available, the UE provides the mapping of each S-NSSAI of the Requested NSSAI to a corresponding HPLMN S-NSSAI.

When a UE registers with a PLMN, if for this PLMN the UE has not included a Requested NSSAI nor a GUAMI while establishing the connection to the (R)AN, the (R)AN shall route all NAS signalling from/to this UE to/from a default AMF. When receiving from the UE a Requested NSSAI and a 5G-S-TMSI or a GUAMI in RRC Connection Establishment or in the establishment of connection to N3IWF/TNGF, if the 5G-AN can reach an AMF corresponding to the 5G-S-TMSI or GUAMI, then 5G-AN forwards the request to this AMF. Otherwise, the 5G-AN selects a suitable AMF based on the Requested NSSAI provided by the UE and forwards the request to the selected AMF. If the 5G-AN is not able to select an AMF based on the Requested NSSAI, then the request is sent to a default AMF.

When the AMF selected by the AN during Registration Procedure receives the UE Registration request, or after an AMF selection by MME (i.e. during EPS to 5GS handover) the AMF receives S-NSSAI(s) from SMF+PGW-C in 5GC:
As part of the Registration procedure described in TS 23.502 [3], clause 4.2.2.2.2, or as part of the EPS to 5GS handover using N26 interface procedure described in clause 4.11.1.2.2 in TS 23.502 [3], the AMF may query the UDM to retrieve UE subscription information including the Subscribed S-NSSAIs.
The AMF verifies whether the S-NSSAI(s) in the Requested NSSAI or the S-NSSAI(s) received from SMF+PGW-C are permitted based on the Subscribed S-NSSAIs (to identify the Subscribed S-NSSAIs the AMF may use the mapping to HPLMN S-NSSAIS provided by the UE, in the NAS message, for each S-NSSAI of the Requested NSSAI).
When the UE context in the AMF does not yet include an Allowed NSSAI for the corresponding Access Type, the AMF queries the NSSF (see (B) below for subsequent handling), except in the case when, based on configuration in this AMF, the AMF is allowed to determine whether it can serve the UE (see (A) below for subsequent handling). The IP address or FQDN of the NSSF is locally configured in the AMF.
NOTE 2: The configuration in the AMF depends on operator's policy.
When the UE context in the AMF already includes an Allowed NSSAI for the corresponding Access Type, based on the configuration for this AMF, the AMF may be allowed to determine whether it can serve the UE (see (A) below for subsequent handling).
AMF or NSSF may have previously subscribed to slice load level and/or Observed Service Experience and/or Dispersion Analytics related network data analytics for a Network Slice from NWDAF. If AMF subscribes to analytics, AMF may determine that it cannot serve the UE based on received analytics (see (A) below). If AMF subscribes to Network Slice restriction notification service from NSSF, it may determine that it cannot serve the UE after the restriction notification is received (see (A) below). If AMF does not subscribe to Network Slice restriction notification service from NSSF, NSSF may take the analytics information into account when AMF queries NSSF (see (B) below).
NOTE 3: The configuration in the AMF depends on the operator's policy.
   (A) Depending on fulfilling the configuration as described above, the AMF may be allowed to determine whether it can serve the UE, and the following is performed:
For the mobility from EPS to 5GS, the AMF first derives the serving PLMN value(s) of S-NSSAI(s) based on the HPLMN S-NSSAI(s) in the mapping of Requested NSSAI (in CM-IDLE state) or the HPLMN S-NSSAI(s) received from SMF+PGW-C(in CM-CONNECTED state). After that the AMF regards the derived value(s) as the Requested NSSAI.
For the inter PLMN within 5GC mobility, the new AMF derives the serving PLMN value(s) of S-NSSAI(s) based on the HPLMN S-NSSAI(s) in the mapping of Requested NSSAI. After that the AMF regards the derived value(s) as the Requested NSSAI.
AMF checks whether it can serve all the S-NSSAI(s) from the Requested NSSAI present in the Subscribed S-NSSAIs (potentially using configuration for mapping S-NSSAI values between HPLMN and Serving PLMN), or all the S-NSSAI(s) marked as default in the Subscribed S-NSSAIs in the case that no Requested NSSAI was provided or none of the S-NSSAIs in the Requested NSSAI are permitted, i.e. do not match any of the Subscribed S-NSSAIs or not available at the current UE's Tracking Area (see clause 5.15.3).
If AMF has subscribed to slice load level and/or Observed Service Experience and/or Dispersion Analytics related network data analytics for a Network Slice from NWDAF, or if AMF had received a Network Slice restriction from NSSF, it may use that information to determine whether the AMF can serve the UE on the S-NSSAI(s) in the Requested NSSAI.
If the AMF can serve the S-NSSAIs in the Requested NSSAI, the AMF remains the serving AMF for the UE. The Allowed NSSAI is then composed of the list of S-NSSAI(s) in the Requested NSSAI permitted based on the Subscribed S-NSSAIs and/or the list of S-NSSAI(s) for the Serving PLMN which are mapped to the HPLMN S-NSSAI(s) provided in the mapping of Requested NSSAI permitted based on the Subscribed S-NSSAIs, or, if neither Requested NSSAI nor the mapping of Requested NSSAI was provided or none of the S-NSSAIs in the Requested NSSAI are permitted, all the S-NSSAI(s) marked as default in the Subscribed S-NSSAIs and taking also into account the availability of the Network Slice instances as described in clause 5.15.8 that are able to serve the S-NSSAI(s) in the Allowed NSSAI in the current UE's Tracking Areas in addition to any Network Slice instance restriction for the S-NSSAI(s) in the Allowed NSSAI provided by the NSSF. If the AMF has received NSSRG information for the Subscribed S-NSSAIs as part of the UE subscription information, it shall only include in the Allowed NSSAI S-NSSAIs that all share a common NSSRG (see clause 5.15.x). It also determines the mapping if the S-NSSAI(s) included in the Allowed NSSAI needs to be mapped to Subscribed S-NSSAI(s) values. If no Requested NSSAI is provided, or the mapping of the S-NSSAIs in Requested NSSAI to HPLMN S-NSSAIs is incorrect, or the Requested NSSAI includes an S-NSSAI that is not valid in the Serving PLMN, or the UE indicated that the Requested NSSAI is based on the Default Configured NSSAI, the AMF, based on the Subscribed S-NSSAI(s) and operator's configuration, may also determine the Configured NSSAI for the Serving PLMN and, if applicable, the associated mapping of the Configured NSSAI to HPLMN S-NSSAIs, so these can be configured in the UE. Then Step (C) is executed.
Else, the AMF queries the NSSF (see (B) below).
   (B) When required as described above, the AMF needs to query the NSSF, and the following is performed:
The AMF queries the NSSF, with Requested NSSAI (excluding S-NSSAIs subject to NSSA which are in “Pending” state and are not yet in the Allowed NSSAI, if any), Default Configured NSSAI Indication, mapping of Requested NSSAI to HPLMN S-NSSAIs, the Subscribed S-NSSAIs (with an indication if marked as default S-NSSAI), NSSRG Information (if provided by the UDM, see clause 5.15.x), any Allowed NSSAI it might have for the other Access Type (including its mapping to HPLMN S-NSSAIs), PLMN ID of the SUPI and UE's current Tracking Area.
Based on this information, local configuration, and other locally available information including RAN capabilities in the current Tracking Area for the UE or load level information for a Network Slice instance provided by the NWDAF, the NSSF does the following:
It verifies which S-NSSAI(s) in the Requested NSSAI are permitted based on comparing the Subscribed S-NSSAIs with the S-NSSAIs in the mapping of Requested NSSAI to HPLMN S-NSSAIs. It considers the S-NSSAI(s) marked as default in the Subscribed S-NSSAIs in the case that no Requested NSSAI was provided or no S-NSSAI from the Requested NSSAI are permitted i.e. are not present in the Subscribed S-NSSAIs or not available e.g. at the current UE's Tracking Area. If NSSRG information is provided, the NSSF only selects S-NSSAIs that share a common NSSRG (see clause 5.15.x).
If AMF has not subscribed to Network Slice instance restriction service from NSSF and NSSF has subscribed to slice load level and/or Observed Service Experience and/or Dispersion Analytics related network data analytics for a Network Slice from NWDAF, NSSF may use the analytics information for the determination of the (Network Slice instance(s) and the) list of S-NSSAI(s) in the Allowed NSSAI(s) to serve the UE.
It selects the Network Slice instance(s) to serve the UE. When multiple Network Slice instances in the UE's Tracking Area are able to serve a given S-NSSAI, based on operator's configuration, the NSSF may select one of them to serve the UE, or the NSSF may defer the selection of the Network Slice instance until a NF/service within the Network Slice instance needs to be selected.
It determines the target AMF Set to be used to serve the UE, or, based on configuration, the list of candidate AMF(s), possibly after querying the NRF.
NOTE 4: If the target AMF (s) returned from the NSSF is the list of candidate AMF(s), the Registration Request message can only be redirected via the direct signalling between the initial AMF and the selected target AMF as described in clause 5.15.5.2.3.
It determines the Allowed NSSAI(s) for the applicable Access Type, composed of the list of S-NSSAI(s) in the Requested NSSAI permitted based on the Subscribed S-NSSAIs and/or the list of S-NSSAI(s) for the Serving PLMN which are mapped to the HPLMN S-NSSAIs provided in the mapping of Requested NSSAI permitted based on the Subscribed S-NSSAIs, or, if neither Requested NSSAI nor the mapping of Requested NSSAI was provided or none of the S-NSSAIs in the Requested NSSAI are permitted, all the S-NSSAI(s) marked as default in the Subscribed S-NSSAIs, and taking also into account the availability of the Network Slice instances as described in clause 5.15.8 that are able to serve the S-NSSAI(s) in the Allowed NSSAI in the current UE's Tracking Areas. If NSSRG information applies, the NSSF only selects S-NSSAIs that share a common NSSRG (see clause 5.15.x). It also determines the mapping of each S-NSSAI of the Allowed NSSAI(s) to the Subscribed S-NSSAIs if necessary.
Based on operator configuration, the NSSF may determine the NRF(s) to be used to select NFs/services within the selected Network Slice instance(s).
Additional processing to determine the Allowed NSSAI(s) in roaming scenarios and the mapping to the Subscribed S-NSSAIs, as described in clause 5.15.6.
If no Requested NSSAI is provided or the Requested NSSAI includes an S-NSSAI that is not valid in the Serving PLMN, or the mapping of the S-NSSAIs in Requested NSSAI to HPLMN S-NSSAIs is incorrect, or the Default Configured NSSAI Indication is received from AMF, the NSSF based on the Subscribed S-NSSAI(s) and operator configuration may also determine the Configured NSSAI for the Serving PLMN and, if applicable, the associated mapping of the Configured NSSAI to HPLMN S-NSSAIS, so these can be configured in the UE.
The NSSF returns to the current AMF the Allowed NSSAI for the applicable Access Type, the mapping of each S-NSSAI of the Allowed NSSAI to the Subscribed S-NSSAIs if determined and the target AMF Set, or, based on configuration, the list of candidate AMF(s). The NSSF may return the NRF(s) to be used to select NFs/services within the selected Network Slice instance(s), and the NRF to be used to determine the list of candidate AMF(s) from the AMF Set. The NSSF may return NSI ID (s) to be associated to the Network Slice instance(s) corresponding to certain S-NSSAIs. NSSF may return the rejected S-NSSAI(s) as described in clause 5.15.4.1. The NSSF may return the Configured NSSAI for the Serving PLMN and the associated mapping of the Configured NSSAI to HPLMN S-NSSAIs.
Depending on the available information and based on configuration, the AMF may query the appropriate NRF (e.g. locally pre-configured or provided by the NSSF) with the target AMF Set. The NRF returns a list of candidate AMFs.
If AMF Re-allocation is necessary, the current AMF reroutes the Registration Request or forwards the UE context to a target serving AMF as described in clause 5.15.5.2.3.
Step (C) is executed.
   (C) The serving AMF shall determine a Registration Area such that all S-NSSAIs of the Allowed NSSAI for this Registration Area are available in all Tracking Areas of the Registration Area (and also considering other aspects as described in clause 5.3.2.3) and then return to the UE this Allowed NSSAI and the mapping of the Allowed NSSAI to the Subscribed S-NSSAIs if provided. The AMF may return the rejected S-NSSAI(s) as described in clause 5.15.4.1.
NOTE 5: The S-NSSAIs in the Allowed NSSAI for Non-3GPP access are available homogeneously in the PLMN for the N3IWF case. For other types of Non 3GPP access the S-NSSAIs in the Allowed NSSAI for Non-3GPP access can be not available homogeneously all over the PLMN, for example different W-AGFs can support different TAIs that support different network slices.

When either no Requested NSSAI was included, or the mapping of the S-NSSAIs in Requested NSSAI to HPLMN S-NSSAIs is incorrect, or a Requested NSSAI is not considered valid in the PLMN and as such at least one S-NSSAI in the Requested NSSAI was rejected as not usable by the UE in the PLMN, or the UE indicated that the Requested NSSAI is based on the Default Configured NSSAI, the AMF may update the UE slice configuration information for the PLMN as described in clause 5.15.4.2.

If the Requested NSSAI does not include S-NSSAIs which map to S-NSSAIs of the HPLMN subject to Network Slice-Specific Authentication and Authorization and the AMF determines that no S-NSSAI can be provided in the Allowed NSSAI for the UE in the current UE's Tracking Area and if no default S-NSSAI(s) could be added as described in step (A), the AMF shall reject the UE Registration and shall include in the rejection message the list of Rejected S-NSSAIs, each of them with the appropriate rejection cause value.

If the Requested NSSAI includes S-NSSAIs which map to S-NSSAIs of the HPLMN subject to Network Slice-Specific Authentication and Authorization, the AMF shall include in the Registration Accept message an Allowed NSSAI containing only those S-NSSAIs that are not to be subject to Network Slice-Specific Authentication and Authorization and, based on the UE Context in AMF, those S-NSSAIs for which Network Slice-Specific Authentication and Authorization for at least one of the corresponding HPLMN S-NSSAIs succeeded previously regardless the Access Type, if any.

The AMF shall also provide the list of Rejected S-NSSAIs, each of them with the appropriate rejection cause value.

The S-NSSAIs which map to S-NSSAIs of the HPLMN subject to Network Slice-Specific Authentication and Authorization is ongoing are in “pending” state in the AMF and shall be included in the Pending NSSAI. The Pending NSSAI may contain a mapping of the S-NSSAI(s) for the Serving PLMN to the HPLMN S-NSSAIs, if applicable. The UE shall not include in the Requested NSSAI any of the S-NSSAIs from the Pending NSSAI the UE stores, regardless of the Access Type.

If:
all the S-NSSAI(s) in the Requested NSSAI are still to be subject to Network Slice-Specific Authentication and Authorization; or
no Requested NSSAI was provided or none of the S-NSSAIs in the Requested NSSAI matches any of the Subscribed S-NSSAIs, and all the S-NSSAI(s) marked as default in the Subscribed S-NSSAIs are to be subject to Network Slice-Specific Authentication and Authorization;
   the AMF shall provide an empty Allowed NSSAI to the UE in the Registration Accept message. Upon receiving an empty Allowed NSSAI, the UE is registered in the PLMN but shall wait for the completion of the Network Slice-Specific Authentication and Authorization without attempting to use any service provided by the PLMN on any access, except e.g. emergency services (see TS 24.501 [47]), until the UE receives an allowed NSSAI.

Then, the AMF shall initiate the Network Slice-Specific Authentication and Authorization procedure as described in clause 5.15.10 for each S-NSSAI that requires it, except, based on Network policies, for those S-NSSAIs for which Network Slice-Specific Authentication and Authorization have been already initiated on another Access Type for the same S-NSSAI(s). At the end of the Network Slice-Specific Authentication and Authorization steps, the AMF by means of the UE Configuration Update procedure shall provide a new Allowed NSSAI to the UE which also contains the S-NSSAIs subject to Network Slice-Specific Authentication and Authorization for which the authentication and authorization is successful. The AMF may perform AMF selection when NSSAA completes for the S-NSSAIs subject to S-NSSAI in “pending” status. If an AMF change is required, this shall be triggered by the AMF using the UE Configuration Update procedure indicating a UE re-registration is required. The S-NSSAIs which were not successfully authenticated and authorized are not included in the Allowed NSSAI and are included in the list of Rejected S-NSSAIs with a rejection cause value indicating Network Slice-Specific Authentication and Authorization failure.

Once completed the Network Slice-Specific Authentication and Authorization procedure, if the AMF determines that no S-NSSAI can be provided in the Allowed NSSAI for the UE, which is already authenticated and authorized successfully by a PLMN, and if no default S-NSSAI(s) could be added as described in step (A), the AMF shall execute the Network-initiated Deregistration procedure described in TS 23.502 [3], clause 4.2.2.3.3, and shall include in the explicit De-Registration Request message the list of Rejected S-NSSAIs, each of them with the appropriate rejection cause value.

If an S-NSSAI is rejected with a rejection cause value indicating Network Slice-Specific Authentication and Authorization failure or revocation, the UE can re-attempt to request the S-NSSAI based on policy, local in the UE.

### <5.15.6 Network Slicing Support for Roaming>

For roaming scenarios:
If the UE only uses standard S-NSSAI values, then the same S-NSSAI values can be used in VPLMN as in the HPLMN.
If the VPLMN and HPLMN have an SLA to support non-standard S-NSSAI values in the VPLMN, the NSSF of the VPLMN maps the Subscribed S-NSSAIs values to the respective S-NSSAI values to be used in the VPLMN. The S-NSSAI values to be used in the VPLMN are determined by the NSSF of the VPLMN based on the SLA. The NSSF of the VPLMN need not inform the HPLMN of which values are used in the VPLMN.

Depending on operator's policy and the configuration in the AMF, the AMF may decide the S-NSSAI values to be used in the VPLMN and the mapping to the Subscribed S-NSSAIs.
The UE constructs Requested NSSAI and provides the mapping of S-NSSAIs of the Requested NSSAI to HPLMN S-NSSAIs if the mapping is stored in the UE, as described in clause 5.15.5.2.1.
The NSSF in the VPLMN determines the Allowed NSSAI without interacting with the HPLMN.
the HPLMN may provide NSSRG Information as part of the Subscription information as described in clause 5.15.x.
The Allowed NSSAI in the Registration Accept includes S-NSSAI values used in the VPLMN. The mapping information described above is also provided to the UE with the Allowed NSSAI as described in clause 5.15.4.
In PDU Session Establishment procedure, the UE includes both:
(a) the S-NSSAI that matches the application (that is triggering the PDU Session Request) within the NSSP in the URSP rules or within the UE Local Configuration as defined in clause 6.1.2.2.1 of TS 23.503 [45]; the value of this S NSSAI is used in the HPLMN; and
(b) an S-NSSAI belonging to the Allowed NSSAI that maps to (a) using the mapping of the Allowed NSSAI to HPLMN S-NSSAIs; the value of this S-NSSAI is used in the VPLMN.

For the home routed case, the V-SMF sends the PDU Session Establishment Request message to the H-SMF along with the S-NSSAI with the value used in the HPLMN (a).
When a PDU Session is established, the CN provides to the AN the S-NSSAI with the value from the VPLMN corresponding to this PDU Session, as described in clause 5.15.5.3.
The Network Slice instance specific network functions in the VPLMN are selected by the VPLMN by using the S-NSSAI with the value used in the VPLMN and querying an NRF that has either been pre-configured, or provided by the NSSF in the VPLMN. The Network Slice specific functions of the HPLMN (if applicable) are selected by the VPLMN by using the related S-NSSAI with the value used in the HPLMN via the support from an appropriate NRF in the HPLMN, identified as specified in clause 4.17.5 of TS 23.502 [3] and, for SMF in clause 4.3.2.2.3.3 of TS 23.502 [3].

### <5.15.x Support of Subscription-Based Restrictions Simultaneous Registration of Network Slices>

### <5.15.x.1 General>

The subscription information for a UE may include for each S-NSSAI Network Slice Simultaneous Registration Group (NSSRG) information constraining which S-NSSAIs can be simultaneously provided to the UE in the Allowed NSSAI.

Two S-NSSAIs sharing at least one NSSRG can be simultaneously included in the Allowed NSSAI. Otherwise, these S-NSSAIs cannot be included simultaneously in the Allowed NSSAI.

The NSSRG information, defining the association of S-NSSAIs to NSSRG, is provided as an additional and separate information.

If the optional NSSRG information is not present for the S-NSSAIs of a subscription, and other restrictions do not apply e.g. availability at a specific location, then it is assumed that all the S-NSSAIs in the subscription information can be simultaneously provided to the UE in the Allowed NSSAI. However, if NSSRG information is present in the subscription information, at least one NSSRG shall be associated with each of the S-NSSAIs in the subscription information. At any time, if the AMF has received subscription information for a UE that includes NSSRG information, the Allowed NSSAI for the UE can only include S-NSSAIs which share a common NSSRG.

The default S-NSSAIs, if more than one is present, are associated with the same NSSRGs, i.e. the UE is always allowed to be registered with all the default S-NSSAIs simultaneously. The HPLMN only sends S-NSSAIs sharing all the NSSRGs of the Default S-NSSAIs to a non-supporting VPLMN as part of the subscription information, i.e. in addition to the default S-NSSAI(s), the HPLMN may send any other subscribed S-NSSAI which shares at least all the NSSRG defined for the default S-NSSAI(s), and the HPLMN sends no NSSRG information to the VPLMN. A subscription information that includes NSSRG information shall include at least one default S-NSSAI.

A supporting AMF/NSSF, when it receives a Requested NSSAI, evaluates the S-NSSAIs of the HPLMN (in the mapping information of the Requested NSSAI, when a mapping information is applicable) based on any received NSSRG information for these S-NSSAIs, to determines whether they can be provided together in the Allowed NSSAI.
NOTE: An HPLMN enabling support of subscription-based restrictions to simultaneous registration of network slices for a Subscriber, can set the subscribed S-NSSAI(s) already in the subscription information before the NSSRG information was added to the subscription information, to have the same NSSRG values defined for the default S-NSSAI(s) if it has to continue to support the same service behaviour for these S-NSSAIs.

### <5.15.x.2 UE and UE Configuration Aspects>

A UE may support the subscription-based restrictions to simultaneous registration of network slice feature. In this case, the UE indicates its support in the Registration Request message in the Initial Registration and the Mobility Registration Update. The supporting AMF stores in the UE context whether the UE has indicated support for the feature.

When the serving PLMN AMF provides the Configured NSSAI to the UE, and the UE has indicated it supports the subscription-based restrictions to simultaneous registration of network slices feature, the AMF also provides the UE with the NSSRG information related to the S-NSSAIs of the HPLMN which are in the mapping information of the Configured NSSAI. A UE which receives the NSSRG values in the network slicing configuration information shall only include in the Requested NSSAI S-NSSAIs that share a common NSSRG as per the received information. If the HPLMN changes NSSRG information in the subscription information for a UE, the UDM updates the supporting AMF serving the UE with the new NSSRG information and the AMF updates the UE as necessary with network slicing configuration by means of the UE Configuration Update procedure (this may include changes in the Configured NSSAI (and related mapping information) and changes in the Allowed NSSAI as applicable). The UE acknowledges this UE Configuration Update as per clause 4.2.4.2 in TS 23.502 [3].

An AMF which supports the subscription-based restrictions to simultaneous registration of network slice feature configures a non-supporting UE with a Configured NSSAI including only compatible S-NSSAIs, except if it has been instructed otherwise by the UDM. In addition to the default S-NSSAI(s), the AMF sends to the UE in the Configured NSSAI any other subscribed S-NSSAI whose NSSRG match at least those defined for the default S-NSSAI(s).

The UDM in a supporting HPLMN may optionally keep a record of the PEIs or Type Allocation Codes values regarding UE ability to handle network slices that cannot be provided simultaneously in Allowed NSSAI.

The UDM may, based on configuration or the optional PEI records, indicate the AMF to provide the non-supporting UEs with the full set of subscribed S-NSSAIs even if they do not share a common NSSRG. The UDM instructs the supporting AMFs of a PLMN to do so by indicating that the UE can be given a Configured NSSAI with all the S-NSSAIs in the subscription information.

Based on its policy (including configuration or optionally checking the specific PEI or Type Allocation Code used by the UE, and subject to roaming agreement) the UDM may also provide the serving AMF in a non-supporting VPLMN with all the S-NSSAI in the subscription information. In this case the AMF provides the UE with a Configured NSSAI including all the S-NSSAIs in the subscription information the AMF receives.

The AMF provides no NSSRG information to a non-supporting UE.

When an AMF which supports the subscription-based restrictions to simultaneous registration of network slice feature, receives from a supporting UE a Requested NSSAI including S-NSSAIs that are supported in the Tracking Area but do not share a common NSSRG, the AMF assumes the UE configuration is not up-to-date, and it provides the UE with an updated configuration including the up-to-date NSSRG information for the S-NSSAIs in the Configured NSSAI as described above.

<5.15.x.2 UE and UE Configuration Aspects when the UE is Accessing 3GPP Access and Non-3GPP Access>

When the UE receives a NSSRG policy over an access type (e.g. 3GPP access type), the UE shall apply the NSSRG policy to another access type (e.g. non-3GPP access type). In addition, the network sends an indication in the registration accept message over the access type indicating whether the UE shall apply NSSRG policy on the NAS or AS procedure over an access type independent of another access type. If the network indicates that the UE applies the NSSRG policy to the NAS or AS procedure over an access type independent NSSRG policy over the other access type, then S-NSSAI(s) in the requested NSSAI of an access type does not depend on the allowed NSSAI of the other access type as per the NSSRG policy i.e. the Requested NSSAI over an access type may contain an S-NSSAI which does not share the common NSSRG with the S-NSSAI(s) of the allowed NSSAI over the second access type.

While the disclosure has been particularly shown and described with reference to exemplary Aspects thereof, the disclosure is not limited to these Aspects. It will be understood by those of ordinary skill in the art that various changes in form and details may be made therein without departing from the spirit and scope of the present disclosure as defined by this document. For example, the Aspects above are not limited to 5GS, and the Aspects are also applicable to communication system other than 5GS.

The whole or part of the example Aspects disclosed above can be described as, but not limited to, the following supplementary notes.
supplementary note 1. A method of a core network apparatus comprising:
receiving, from a Unified Data Management (UDM), information indicating Network Slice Simultaneous Registration Group (NSSRG),
wherein the information is related to access type;
determining Allowed Network Slice Selection Assistance Information (NSSAI) based on the information; and
sending, to a User Equipment (UE), the Allowed NSSAI and the information.
supplementary note 2. A method of a User Equipment (UE) comprising:
receiving, from an Access and Mobility Management Function (AMF), information indicating Network Slice Simultaneous Registration Group (NSSRG),
wherein the information is related to access type; and
determining Requested Network Slice Selection Assistance Information (NSSAI) based on the information.
supplementary note 3. A method of a core network apparatus comprising:
receiving, from an Access and Mobility Management Function (AMF), a message; and
sending, to the AMF, information indicating Network Slice Simultaneous Registration Group (NSSRG),
wherein the information is related to access type.
supplementary note 4. A method of a core network apparatus in a first Public Land Mobile Network (PLMN), the method comprising:
receiving, from a User Equipment (UE), a Registration Request message,
wherein the Registration Request message includes Requested NSSAI;
receiving, from a Unified Data Management (UDM), Allowed NSSAI of a second PLMN;
determining Allowed NSSAI of the first PLMN based on the Requested NSSAI, the Allowed NSSAI of the second PLMN and information indicating Network Slice Simultaneous Registration Group (NSSRG),
wherein the information is related to access type; and
sending, to the UE, the Allowed NSSAI of the first PLMN and the information.
supplementary note 5. The method according to supplementary note 4,
wherein the information is received from the UDM.
supplementary note 6. A method of a User Equipment (UE) comprising:
performing a registration procedure via a first access type;
checking whether first Single Network Slice Selection Assistance Information (S-NSSAI) is included in Network Slice Simultaneous Registration Group (NSSRG) of the first access type based on information indicating the NSSRG and Allowed Network Slice Selection Assistance Information (NSSAI) of the first access type,
wherein the first S-NSSAI is used for a registration procedure via a second access type, and
wherein the NSSRG includes second S-NSSAI of Allowed NSSAI of the first access type; and
sending a Registration Request message via the second access type in a case where the first S-NSSAI is included in the NSSRG,
wherein the Registration Request message includes Requested NSSAI set to the first S-NSSAI.
supplementary note 7. A method of an Access and Mobility Management Function (AMF) comprising:
performing a registration procedure via a first access type;
receiving, from a User Equipment (UE), a Registration Request message via a second access type,
wherein the Registration Request message includes Requested Network Slice Selection Assistance Information (NSSAI) set to first Single Network Slice Selection Assistance Information (S-NSSAI);
checking whether the first S-NSSAI is included in Network Slice Simultaneous Registration Group (NSSRG) of the first access type based on information indicating the NSSRG and Allowed NSSAI of the first access type,
wherein the NSSRG includes second S-NSSAI of the Allowed NSSAI of the first access type; and
sending, to the UE, a Registration Accept message in a case where the first S-NSSAI is included in the NSSRG,
wherein the Registration Accept message includes Allowed NSSAI of the second access type, and
wherein the Allowed NSSAI of the second access type is set to the first S-NSSAI.
supplementary note 8. A method of a first Access and Mobility Management Function (AMF) comprising:
receiving, from a User Equipment (UE), a Registration Request message,
wherein the Registration Request message includes 5G Globally Unique Temporary Identifier (5G-GUTI);
sending, to a second AMF, the 5G-GUTI;
receiving, from the second AMF, information indicating Network Slice Simultaneous Registration Group (NSSRG); and
determining Allowed Network Slice Selection Assistance Information (NSSAI) based on the information.
supplementary note 9. A method of a Radio Access Network (RAN) node comprising:
receiving, from an Access and Mobility Management Function (AMF), first information indicating Network Slice Simultaneous Registration Group (NSSRG); and
selecting a target cell of a target RAN for a handover based on the first information, second information indicating a network slice supported in the target RAN, and third information indicating NSSRG related to the network slice.
supplementary note 10. A core network apparatus comprising:
means for receiving, from a Unified Data Management (UDM), information indicating Network Slice Simultaneous Registration Group (NSSRG),
wherein the information is related to access type;
means for determining Allowed Network Slice Selection Assistance Information (NSSAI) based on the information; and
means for sending, to a User Equipment (UE), the Allowed NSSAI and the information.
supplementary note 11. A User Equipment (UE) comprising: means for receiving, from an Access and Mobility Management Function (AMF), information indicating Network Slice Simultaneous Registration Group (NSSRG),
wherein the information is related to access type; and
means for determining Requested Network Slice Selection Assistance Information (NSSAI) based on the information.
supplementary note 12. A core network apparatus comprising:
means for receiving, from an Access and Mobility Management Function (AMF), a message; and
means for sending, to the AMF, information indicating Network Slice Simultaneous Registration Group (NSSRG),
wherein the information is related to access type.
supplementary note 13. A core network apparatus in a first Public Land Mobile Network (PLMN), the core network comprising:
means for receiving, from a User Equipment (UE), a Registration Request message,
wherein the Registration Request message includes Requested NSSAI;
means for receiving, from a Unified Data Management (UDM), Allowed NSSAI of a second PLMN;
means for determining Allowed NSSAI of the first PLMN based on the Requested NSSAI, the Allowed NSSAI of the second PLMN and information indicating Network Slice Simultaneous Registration Group (NSSRG),
wherein the information is related to access type; and
means for sending, to the UE, the Allowed NSSAI of the first PLMN and the information.
supplementary note 14. The core network apparatus according to claim 13,
wherein the information is received from the UDM.
supplementary note 15. A User Equipment (UE) comprising: means for performing a registration procedure via a first access type;
means for checking whether first Single Network Slice Selection Assistance Information (S-NSSAI) is included in Network Slice Simultaneous Registration Group (NSSRG) of the first access type based on information indicating the NSSRG and Allowed Network Slice Selection Assistance Information (NSSAI) of the first access type,
wherein the first S-NSSAI is used for a registration procedure via a second access type, and
wherein the NSSRG includes second S-NSSAI of Allowed NSSAI of the first access type; and
means for sending a Registration Request message via the second access type in a case where the first S-NSSAI is included in the NSSRG,
wherein the Registration Request message includes Requested NSSAI set to the first S-NSSAI.
supplementary note 16. An Access and Mobility Management Function (AMF) comprising:
means for performing a registration procedure via a first access type;
means for receiving, from a User Equipment (UE), a Registration Request message via a second access type,
wherein the Registration Request message includes Requested Network Slice Selection Assistance Information (NSSAI) set to first Single Network Slice Selection Assistance Information (S-NSSAI);
means for checking whether the first S-NSSAI is included in Network Slice Simultaneous Registration Group (NSSRG) of the first access type based on information indicating the NSSRG and

Allowed NSSAI of the first access type,
wherein the NSSRG includes second S-NSSAI of the Allowed NSSAI of the first access type; and
means for sending, to the UE, a Registration Accept message in a case where the first S-NSSAI is included in the NSSRG,
wherein the Registration Accept message includes Allowed NSSAI of the second access type, and
wherein the Allowed NSSAI of the second access type is set to the first S-NSSAI.
supplementary note 17. A first Access and Mobility Management Function (AMF) comprising:
means for receiving, from a User Equipment (UE), a Registration Request message,
wherein the Registration Request message includes 5G Globally Unique Temporary Identifier (5G-GUTI);
means for sending, to a second AMF, the 5G-GUTI;
means for receiving, from the second AMF, information indicating Network Slice Simultaneous Registration Group (NSSRG); and
means for determining Allowed Network Slice Selection Assistance Information (NSSAI) based on the information.
supplementary note 18. A Radio Access Network (RAN) node comprising:
means for receiving, from an Access and Mobility Management Function (AMF), first information indicating Network Slice Simultaneous Registration Group (NSSRG); and
means for selecting a target cell of a target RAN for a handover based on the first information, second information indicating a network slice supported in the target RAN, and third information indicating NSSRG related to the network slice.
supplementary note 19. A method of first core network apparatus comprising:
receiving, from a communication terminal, a Registration Request message;
sending, to a second core network apparatus, a request message to get subscription parameter for the communication terminal;
receiving, from the second core network apparatus, information indicating Network Slice Simultaneous Selection Group (NSSRG) corresponding to access type or Radio Access Technology (RAT) type; and
sending, to the communication terminal, a message including the information indicating the NSSRG.
supplementary note 20. A method of a communication terminal comprising:
sending, to a first core network apparatus, a Registration Request message related to Requested Network Slice Selection Assistance Information (NSSAI);
receiving, from the first core network apparatus, a Registration Accept message including information indicating Network Slice Simultaneous Selection Group (NSSRG) related to an access type; and
applying the information indicating the NSSRG to the Requested NSSAI for constituting the Requested NSSAI.
supplementary note 21. A method of a second core network apparatus, comprising:
receiving, from a communication terminal, a Registration Request message related to the second core network apparatus;
sending, to a third core network apparatus, a request message to get parameter for the communication terminal;
receiving, from the third core network apparatus, information indicating first Allowed Network Slice Selection Assistance Information (NSSAI) of a first Public Land Mobile Network (PLMN) and Configured NSSAI of the first PLMN related to a first core network apparatus;
checking second Allowed NSSAI of a second PLMN related to the second core network apparatus based on information indicating Network Slice Simultaneous Selection Group (NSSRG), the first Allowed NSSAI of the first PLMN, and the Configured NSSAI of the first PLMN; and
sending, to the communication terminal, a Registration Accept message including at least one of the second Allowed NSSAI.
supplementary note 22. A method of a communication terminal comprising:
initiating a registration procedure over a first access type;
receiving trigger information to register first Single Network Slice Selection Assistance Information (S-NSSAI) over a second access type;
checking whether the first S-NSSAI is included in a Network Slice Simultaneous Registration Group (NSSRG) of the first access type based on information indicating the NSSRG and Allowed Network Slice Selection Assistance Information (NSSAI) of the first access type; and
sending a Registration request message in a case where the first S-NSSAI is included in the NSSRG of the first access type.
supplementary note 23. A method of a first core network apparatus comprising:
receiving, from a communication terminal, a Registration Request message;
sending, to second core network apparatus, a request message to get control information for the communication terminal; and
receiving, from the second core network apparatus, a response message including information indicating Network Slice Simultaneous Selection Group (NSSRG).
supplementary note 24. A method of a first core network apparatus comprising:
receiving, from a communication terminal, a Registration Request message;
sending, to a second core network apparatus, a request message to get information for the communication terminal;
receiving, from the second core network apparatus, a message including information indicating Network Slice Simultaneous Selection Group (NSSRG) related to access type information; and
sending, to a Radio Access Network (RAN), a second message including Allowed Network Slice Selection Assistance Information (NSSAI) and information indicating the NSSRG related to the access type,
wherein the RAN sends to the communication terminal a Registration Accept message including Allowed NSSAI and information indicating NSSRG, and
wherein the RAN receives, from the communication terminal, a Registration complete message in a case where the RAN handovers to another RAN based on the information indicating the NSSRG.
supplementary note 25. A method of a User Equipment (UE) comprising:
performing communication with a network apparatus; and
including first Single Network Slice Selection Assistance Information (S-NSSAI) to Requested Network Slice Selection Assistance Information (NSSAI) for a first access,
wherein the first S-NSSAI shares Network Slice Simultaneous Registration Group (NSSRG) common to second S-NSSAI of Allowed NSSAI for a second access.
supplementary note 26. The method according to supplementary note 25, further comprising:
sending a registration request message,
wherein the registration request message includes the Requested NSSAI.
supplementary note 27. The method according to supplementary note 25 or 26, further comprising:
receiving information related to the NSSRG.
supplementary note 28. The method according to supplementary note 27,
wherein the information is included in a registration accept message.
supplementary note 29. A User Equipment (UE) comprising:
means for performing communication with a network apparatus; and
means for including first Single Network Slice Selection Assistance Information (S-NSSAI) to Requested Network Slice Selection Assistance Information (NSSAI) for a first access,
wherein the first S-NSSAI shares Network Slice Simultaneous Registration Group (NSSRG) common to second S-NSSAI of Allowed NSSAI for a second access.
supplementary note 30. The UE according to supplementary note 29, further comprising:
means for sending a registration request message,
wherein the registration request message includes the Requested NSSAI.
supplementary note 31. The UE according to supplementary note 29 or 30, further comprising:
means for receiving information related to the NSSRG.
supplementary note 32. The UE according to supplementary note 31,
wherein the information is included in a registration accept message.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Indian provisional patent application No. 20/211,1025931, filed on Jun. 10, 2021, the disclosure of which is incorporated herein in its entirety by reference.

### REFERENCE SIGNS LIST

1 telecommunication system
3 UE
5 (R)AN node
7 core network
20 data network
31 transceiver circuit
32 antenna
33 controller
34 user interface
35 USIM
36 memory
51 transceiver circuit
52 antenna
53 network interface
54 controller
55 memory
60 RU
61 DU
62 CU
70 AMF
71 SMF
72 UPF
73 PCF
74 NEF
75 UDM
76 NWDAF
361 operating system
362 communications control module
551 operating system
552 communications control module
601 transceiver circuit
602 antenna
603 network interface
604 controller
605 memory
611 transceiver circuit
612 network interface
613 controller
614 memory
621 transceiver circuit
622 network interface
623 controller
624 memory
701 transceiver circuit
702 network interface
703 controller
704 memory
751 transceiver circuit
752 network interface
753 controller
754 memory
3621 transceiver control module
5521 transceiver control module
6051 operating system
6052 communications control module
6141 operating system
6142 communications control module
6241 operating system
6242 communications control module
7041 operating system
7042 communications control module
7541 operating system
7542 communications control module
60521 transceiver control module
61421 transceiver control module
62421 transceiver control module
70421 transceiver control module
75421 transceiver control module

What is claimed is:

1. A method of a User Equipment (UE) comprising:
communicating with a communication apparatus; and
sending a registration request message,
wherein the registration request message includes Requested Network Slice Selection Assistance Information (NSSAI) for a first access,
wherein the Requested NSSAI includes first Single Network Slice Selection Assistance Information (S-NSSAI), and
wherein the first S-NSSAI shares Network Slice Simultaneous Registration Group (NSSRG) common to second S-NSSAI of Allowed NSSAI for a second access.

2. The method according to claim 1, further comprising:
receiving information related to the NSSRG.

3. The method according to claim 2,
wherein the information is included in a registration accept message.

4. The method according to claim 1,
wherein the communication apparatus is an Access and Mobility Management Function (AMF).

5. A User Equipment (UE) comprising:
at least one memory; and
at least one hardware processor coupled to the at least one memory,
wherein the at least one hardware processor is configured to:
communicate with a communication apparatus; and
send a registration request message,
wherein the registration request message includes Requested Network Slice Selection Assistance Information (NSSAI) for a first access,
wherein the Requested NSSAI includes first Single Network Slice Selection Assistance Information (S-NSSAI), and
wherein the first S-NSSAI shares Network Slice Simultaneous Registration Group (NSSRG) common to second S-NSSAI of Allowed NSSAI for a second access.

6. A method of a communication apparatus comprising:
communicating with a User Equipment (UE); and
receiving a registration request message,
wherein the registration request message includes Requested Network Slice Selection Assistance Information (NSSAI) for a first access,
wherein the Requested NSSAI includes first Single Network Slice Selection Assistance Information (S-NSSAI), and
wherein the first S-NSSAI shares Network Slice Simultaneous Registration Group (NSSRG) common to second S-NSSAI of Allowed NSSAI for a second access.

7. The method according to claim 6, further comprising:
sending information related to the NSSRG.

8. The method according to claim 7,
wherein the information is included in a registration accept message.

9. The method according to claim 6,
wherein the communication apparatus is an Access and Mobility Management Function (AMF).

10. A communication apparatus comprising:
at least one memory; and
at least one hardware processor coupled to the at least one memory,
wherein the at least one hardware processor is configured to:
communicate with a User Equipment (UE); and
receive a registration request message,
wherein the registration request message includes Requested Network Slice Selection Assistance Information (NSSAI) for a first access,
wherein the Requested NSSAI includes first Single Network Slice Selection Assistance Information (S-NSSAI), and
wherein the first S-NSSAI shares Network Slice Simultaneous Registration Group (NSSRG) common to second S-NSSAI of Allowed NSSAI for a second access.
